(19) United States
(12) Patent Application Publication
(10) Pub. No.: US 2013/0083873 A1
(43) Pub. Date: Apr. 4, 2013

(54) INFORMATION REPRODUCTION APPARATUS AND INFORMATION REPRODUCTION METHOD

(71) Applicants: Hajime ISHIHARA, Takaoka (JP); Yusuke Nakamura, Ebina (JP); Yutaka Nagai, Yokohama (JP)

(72) Inventors: Hajime ISHIHARA, Takaoka (JP); Yusuke Nakamura, Ebina (JP); Yutaka Nagai, Yokohama (JP)

(21) Appl. No.: 13/550,640

(22) Filed: Jul. 17, 2012

(30) Foreign Application Priority Data
Sep. 30, 2011 (JP) 2011-216006

(51) Int. Cl. H04L 27/06

(52) U.S. Cl. 375/341

(57) ABSTRACT

An information reproduction apparatus includes a generator of a channel clock synchronized to input data, an analog/digital converter for converting the input data with an 1/N clock which is in frequency one Nth (N: a positive real number) of the channel clock, and a Viterbi decoder including a unit for calculating a branch metric based on a difference between an output of the converter and a reference value, an ACS unit responsive to input of data corresponding to one time point of the 1/N clock, for adding the branch metric for one time point to an old path metric, comparing addition results, selecting a smaller result, and outputting a new path metric and a path selection signal, according to state transitions with N bits as a unit, a unit for determining a maximum likelihood path based on the selection signal, and a decoder for outputting a decoding result.

### INCORPORATION BY REFERENCE

The present application claims priority from Japanese application JP2011-216006 filed on Sep. 30, 2011, the content of which is hereby incorporated by reference into this application.

### BACKGROUND OF THE INVENTION

The present invention relates to an apparatus for reproducing information from input data.

JP-A-10-269648 discloses an information reproduction apparatus using a Viterbi decoding method as described below and having a Viterbi decoder including a state data generation unit for conducting parallel processing by taking two consecutive reproduced signal values as a unit on the basis of reproduced signal values sampled in accordance with a channel clock and generating state data every half clock which represents a state transition itself having maximum likelihood, and a decoding data output unit for outputting decoded data on the basis of the state data.

### SUMMARY OF THE INVENTION

The information reproduction apparatus disclosed in JP-A-10-269648 handles two consecutive reproduced signal values as the unit on the basis of reproduced signal values sampled in accordance with the channel clock. Therefore, the information reproduction apparatus cannot conduct Viterbi decoding correctly on reproduced signals sampled at timing according to the half clock.

An object of the present invention is to solve the above-described problem and provide an information reproduction apparatus and an information reproduction method using Viterbi decoding processing corresponding to a reproduced signal sampled by a clock which oscillates at a frequency lower than that of the channel clock and capable of reducing power consumption of the circuit.

Outlines of representative aspects of the invention disclosed here in order to achieve the object will now be described in brevity.

(1) An information reproduction apparatus for reproducing information, including a clock generation unit for generating a channel clock synchronized to input data, an analog/digital conversion unit for conducting analog/digital conversion on the input data with an 1/N clock oscillating at a frequency equivalent to one Nth (where N is a positive real number) of that of the channel clock, and a Viterbi decoding unit for conducting Viterbi decoding, the Viterbi decoding unit including a branch metric operation unit for calculating a branch metric based on a difference between an output of the analog/digital conversion unit and a reference value, an ACS operation unit responsive to input of data corresponding to one time point based upon the 1/N clock, for adding up the branch metric corresponding to one time point of the 1/N clock and an old path metric, comparing results of the addition in magnitude, selecting a smaller addition result, and outputting a new path metric and a path selection signal, in accordance with state transitions in which a state makes a transition with N bits taken as a unit, a maximum likelihood path decision unit for determining a maximum likelihood path based on the path selection signal, and a decoding unit for conducting decoding based on the maximum likelihood path and outputting a decoding result.
(2) An information reproduction apparatus for reproducing information, including a clock generation unit for generating at least one of a channel clock synchronized to input data and an UN clock oscillating with a frequency which is equal to 1/N of that of the channel clock (where N is a positive real number), an analog/digital conversion unit for conducting analog/digital conversion on the input data with an output of the clock generation unit, and a Viterbi decoding unit for conducting Viterbi decoding, the Viterbi decoding unit including a branch metric operation unit for calculating a branch metric based on a difference between an output of the analog/digital conversion unit and a reference value, a first ACS operation unit responsive to input of data corresponding to one time point based upon the 1/N clock, for adding up the branch metric corresponding to one time point of the 1/N clock and an old first path metric, comparing results of the addition in magnitude, selecting a smaller addition result, and outputting a new first path metric and a first path selection signal, in accordance with state transitions in which a state makes a transition with N bits taken as a unit, a second ACS operation unit responsive to input of data corresponding to one time point based upon the channel clock, for adding up the branch metric corresponding to one time point of the channel clock and an old second path metric, comparing results of the addition in magnitude, selecting a smaller addition result, and outputting a new second path metric and a second path selection signal, in accordance with state transitions in which a state makes a transition with one bit taken as a unit, a first maximum likelihood path decision unit for determining a first maximum likelihood path based on the first path selection signal, a second maximum likelihood path decision unit for determining a second maximum likelihood path based on the second path selection signal, a first decoding unit for conducting decoding based on the first maximum likelihood path and outputting a first decoding result, a second decoding unit for conducting decoding based on the second maximum likelihood path and outputting a second decoding result, a data changeover unit for changing over between the first decoding result and the second decoding result and outputting a resultant decoding result, and a control unit for controlling the clock generation unit and the data changeover unit.
(3) An information reproduction apparatus for reproducing information, including a clock generation unit for generating a channel clock synchronized to input data and an 1/N clock oscillating with a frequency which is equal to 1/N of that of the channel clock (where N is a positive real number), a clock changeover means for conducting changeover between the channel clock and the 1/N clock to output either one of the clocks, a control means for controlling the clock changeover means, an analog/digital conversion unit for conducting analog/digital conversion on the input data with an output of the clock generation unit, and a Viterbi decoding unit for conducting Viterbi decoding, the Viterbi decoding unit including a first branch metric operation unit for calculating a first branch metric based on a difference between an output of the analog/digital conversion unit and a reference value, a second branch metric operation unit for calculating a second branch metric based on a difference between the output of the analog/digital conversion unit and a reference value, a branch metric addition unit for adding up the first branch metric and the second branch metric, an ACS operation unit responsive to input of continuous data corresponding to N time points based upon the channel clock, for adding up an output of the branch metric addition unit and an old first path metric, comparing results of the addition in magnitude, selecting a smaller addition result, and outputting a new first path metric and a path selection signal, in accordance with state transitions in which a state makes a transition with N bits taken as a unit, a maximum likelihood path decision unit for determining a maximum likelihood path based on the path selection signal, and a decoding unit for conducting decoding based on the maximum likelihood path and outputting a decoding result.
(4) An information reproduction method for reproducing information, including generating a channel clock synchronized to input data, conducting analog/digital conversion on the input data with an 1/N clock oscillating at a frequency equivalent to one Nth (where N is a positive real number) of that of the channel clock, and conducting Viterbi decoding, the Viterbi decoding including calculating a branch metric based on a difference between a result of the analog/digital conversion and a reference value, responding to input of data corresponding to one time point based upon the 1/N clock, by adding up the branch metric corresponding to one time point of the 1/N clock and an old path metric, comparing results of the addition in magnitude, selecting a smaller addition result, and outputting a new path metric and a path selection signal, in accordance with state transitions in which a state makes a transition with N bits taken as a unit, determining a maximum likelihood path based on the path selection signal; and conducting decoding based on the maximum likelihood path and calculating a decoding result.
(5) An information reproduction method for reproducing information, including generating at least one of a channel clock synchronized to input data and an 1/N clock oscillating with a frequency which is equal to 1/N of that of the channel clock (where N is a positive real number) as a clock, conducting analog/digital conversion on the input data with the clock, and conducting Viterbi decoding, the Viterbi decoding including calculating a branch metric based on a difference between a result of the analog/digital conversion and a reference value, responding to input of data corresponding to one time point based upon the 1/N clock, by adding up the branch metric corresponding to one time point of the 1/N clock and an old first path metric, comparing results of the addition in magnitude, selecting a smaller addition result, and outputting a new first path metric and a first path selection signal, in accordance with state transitions in which a state makes a transition with N bits taken as a unit, responding to input of data corresponding to one time point based upon the channel clock, by adding up the branch metric corresponding to one time point of the channel clock and an old second path metric, comparing results of the addition in magnitude, selecting a smaller addition result, and outputting a new second path metric and a second path selection signal, in accordance with state transitions in which a state makes a transition with one bit taken as a unit, determining a first maximum likelihood path based on the first path selection signal, determining a second maximum likelihood path based on the second path selection signal, conducting decoding based on the first maximum likelihood path and calculating a first decoding result, conducting decoding based on the second maximum likelihood path and calculating a second decoding result, changing over between the first decoding result and the second decoding result and calculating a resultant decoding result, and controlling changeover between generation of the channel clock and generation of the 1/N clock and changeover between the first decoding result and the second decoding result.
(6) An information reproduction method for reproducing information, including generating at least one of a channel clock synchronized to input data and an 1/N clock oscillating with a frequency which is equal to 1/N of that of the channel clock (where N is a positive real number) as a clock, conducting analog/digital conversion on the input data with the clock, and conducting Viterbi decoding, the Viterbi decoding including calculating a first branch metric based on a difference between a result of the analog/digital conversion and a reference value, calculating a second branch metric based on a difference between the result of the analog/digital conversion and a reference value, adding up the first branch metric and the second branch metric, responding to input of continuous data corresponding to N time points based upon the channel clock, by adding up a result of the addition of the first branch metric and the second branch metric and an old first path metric, comparing results of the addition in magnitude, selecting a smaller addition result, and calculating a new first path metric and a path selection signal, in accordance with state transitions in which a state makes a transition with N bits taken as a unit, determining a maximum likelihood path based on the path selection signal, and conducting decoding based on the maximum likelihood path and calculating a decoding result.

According to the present invention, it becomes possible to provide an information reproduction apparatus and an information reproduction method capable of conducting Viterbi decoding corresponding to a reproduced signal sampled by an 1/N clock oscillating at a frequency equivalent to one Nth (where N is a positive real number) of that of the channel clock and capable of reducing the power consumption.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of an information reproduction apparatus according to an embodiment 1 of the present invention;

FIG. 2 is a block diagram showing a configuration of a PLL shown in FIG. 1;

FIG. 3 is a state transition diagram of PR(a, b, c, d, e) in a channel clock sampling and channel clock operation;

FIG. 4 is a trellis diagram of PR(a, b, c, d, e) in a channel clock sampling and channel clock operation;

FIG. 5 is a trellis diagram of PR(a, b, c, d, e) in a half clock sampling and half clock operation;

FIG. 6 is a state transition diagram of PR(a, b, c, d, e) in a half clock sampling and half clock operation;

FIG. 7 is a block diagram showing a configuration of a BMC shown in FIG. 1;

FIG. 8 is a block diagram showing a configuration of an ACS shown in FIG. 1;

FIG. 9 is a block diagram showing a configuration of an A-type ACS shown in FIG. 8;

FIG. 10 is a block diagram showing a configuration of a B-type ACS shown in FIG. 8;

FIG. 11 is a block diagram showing a configuration of a bus memory shown in FIG. 1;

FIG. 12A is a diagram showing a first configuration example of a majority circuit shown in FIG. 11;

FIG. 12B is a diagram showing an operation of the first configuration example;

FIG. 13A is a diagram showing a second configuration example of a majority circuit shown in FIG. 11;

FIG. 13B is a diagram showing an operation of the second configuration example;

FIG. 14 is a block diagram showing a configuration of an information reproduction apparatus according to an embodiment 2 of the present invention;

FIG. 15 is a block diagram showing a configuration of a PR encoder shown in FIG. 14;

FIG. 16 is a block diagram showing a configuration of an information reproduction apparatus according to an embodiment 3 of the present invention;

FIG. 17 is a block diagram showing a configuration of a PLL shown in FIG. 16;

FIG. 18 is a block diagram showing a configuration of a second ACS shown in FIG. 16:

FIG. 19 is a block diagram showing a configuration of a second bus memory shown in FIG. 16;

FIG. 20 is a block diagram showing a configuration of an information reproduction apparatus according to an embodiment 4 of the present invention;

FIG. 21 is a trellis diagram of PR(a, b, c, d, e) in a channel clock sampling and half clock operation;

FIG. 22 is a state transition diagram of PR(a, b, c, d, e) in a channel clock sampling and half clock operation;

FIG. 23 is a block diagram showing a configuration of a PLL shown in FIG. 20;

FIG. 24 is a block diagram showing a configuration of an ACS shown in FIG. 20;

FIG. 25 is a block diagram showing a configuration of a bus memory shown in FIG. 20;

FIG. 26 is a block diagram showing a configuration of an information reproduction apparatus according to an embodiment 5 of the present invention;

FIG. 27 is a block diagram showing a configuration of an interpolator shown in FIG. 26;

FIG. 28 is a block diagram showing a configuration of a decoder shown in FIG. 1; and

FIG. 29 is a flow chart showing a procedure for changing over between the half clock operation and the channel clock operation in the embodiment 3 of the present invention.

### DESCRIPTION OF THE EMBODIMENTS

Hereafter, embodiments of the present invention will be described with reference to the drawings. In the ensuing description, the case where N=2 is taken as an example.

### Embodiment 1

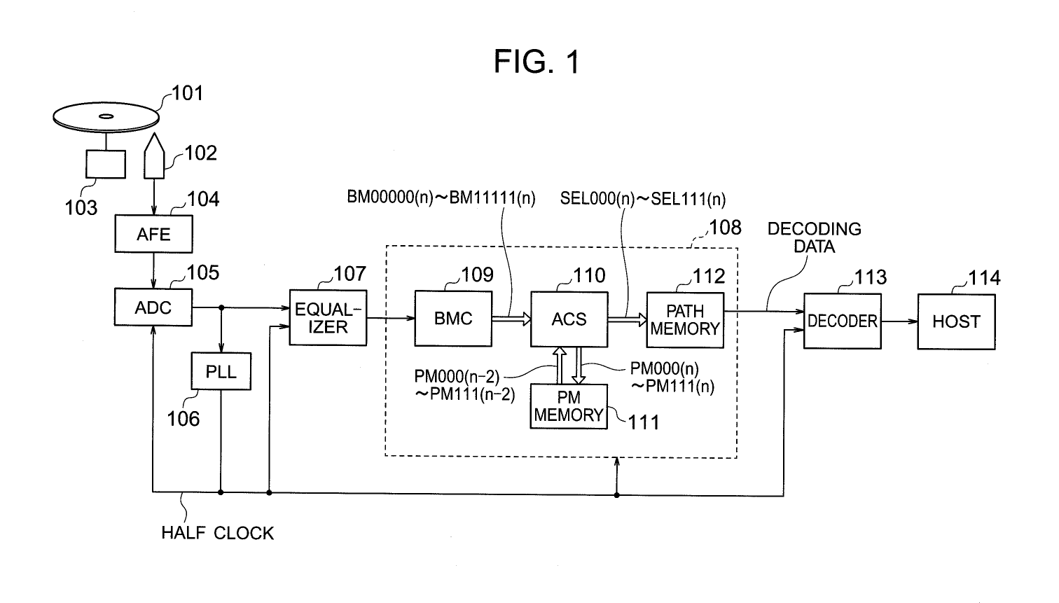

FIG. 1 is a configuration diagram of an information reproduction apparatus according to an embodiment 1 of the present invention.

The present embodiment is an embodiment of an information reproduction apparatus using a PRML (Partial Response Maximum Likelihood) scheme capable of conducting Viterbi decoding corresponding to a reproduced signal sampled by a half clock oscillating at a frequency which is equal to half of that of the channel clock.

An outline of a reproduction operation in the information reproduction apparatus according to the present embodiment will now be described.

As shown in FIG. 1, an optical pickup 102 irradiates an optical disk 101 rotated by a spindle motor 103 with laser light. An AFE (Analog Front End) 104 conducts analog processing on a reproduced signal which is read by receiving reflected light from the optical disk 101. A resulting signal is input to an AD converter (hereafter referred to as ADC) 105. The reproduced signal which is digitized by the ADC 105 is input to a PLL (Phase Locked Loop) 106 and an equalizer 107. The PLL 106 generates a half clock oscillating at a frequency which is equal to half of that of a channel clock of the digitized reproduced signal. The half clock is input to the ADC 105, the equalizer 107, a Viterbi decoder 108, and a decoder 113. The reproduced signal subjected to waveform equalization in the equalizer 107 is subjected to decoding processing in the Viterbi decoder 108, and a resultant signal is input to the decoder 113 as decoding data. As shown in FIG. 28, the decoder 113 conducts in a demodulator 2801 demodulation processing on decoding data which is input, then conducts in an error corrector 2802 error correction operation processing, then conducts in a descrambler 2803 descramble processing, and outputs a resultant signal to a host 114.

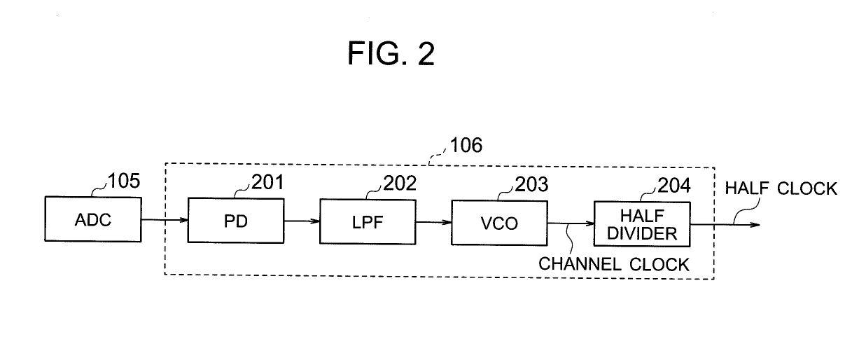

FIG. 2 shows an example of a configuration of the PLL 106.

The reproduced signal digitized by the ADC 105 is input to a PD (Phase Detector) 201 which detects phase error data on the basis of a data deviation at an edge of a reproduced signal waveform. The phase error data cleared of a high frequency component in an LPF (LooP Filter) 202 is input to a VCO (Voltage Controlled Oscillator) 203. The VCO 203 operates to adjust a period and a phase of a sampling clock of the ADC 105 and thereby compensate a phase difference in accordance with the obtained error data and always output a channel clock synchronized to the reproduced signal. A half divider 204 conducts half frequency division on the channel clock which is input from the VCO 203, and generates and outputs a half clock. In the present embodiment, the half divider 204 is provided within the PLL 106 and the reproduced signal sampled at timing based upon the half clock and digitized is generated. Alternatively, however, other methods such as conducting sampling at timing based upon the channel clock and then conducting down sampling may be used.

An outline of Viterbi decoding corresponding to the reproduced signal sampled with the half clock in the present embodiment will now be described in detail.

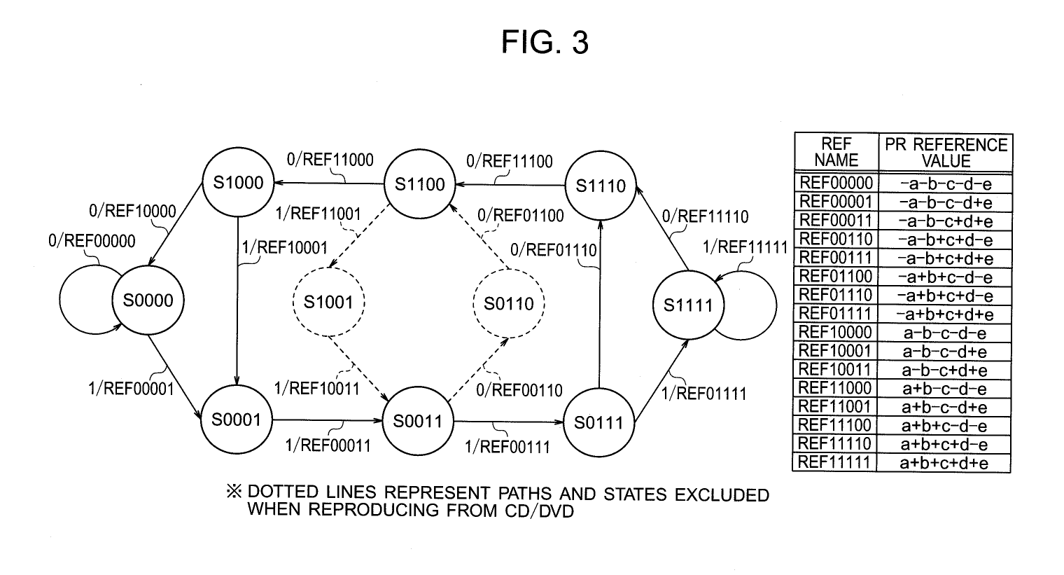

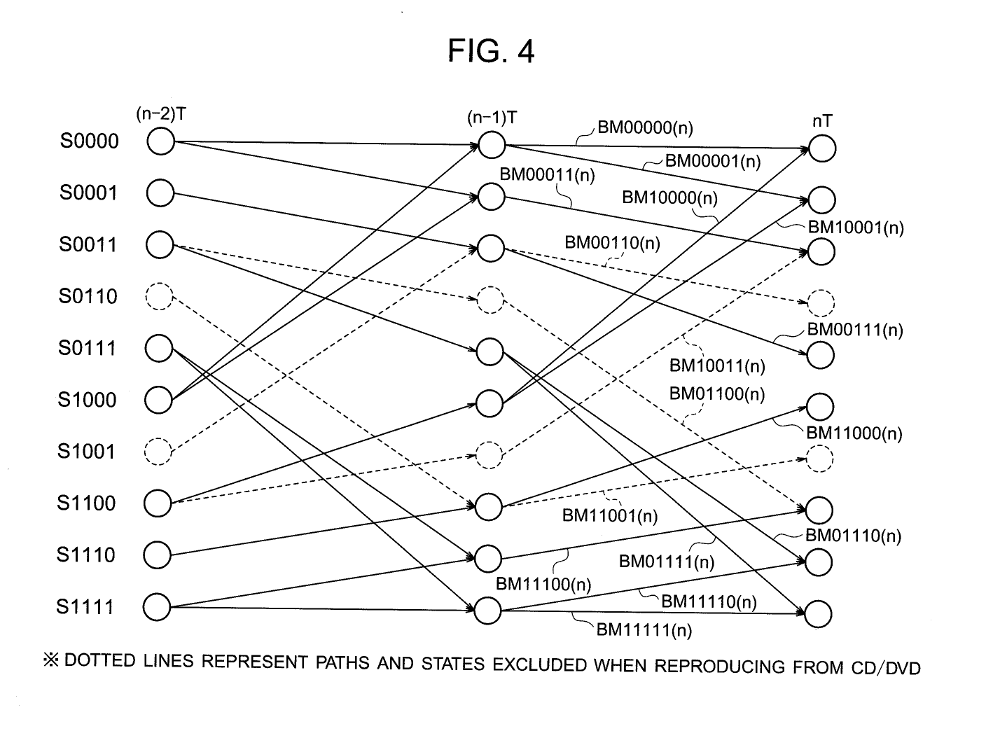

First, FIG. 3 shows a state transition diagram and PR reference values of PR(a, b, c, d, e) having a restraint length of 5 in the case where the shortest mark length on the recording face of a disk is 2T (where T is a time length corresponding to one period based upon timing of the channel clock) in the conventional Viterbi decoding corresponding to a reproduced signal sampled with the channel clock. Parts indicated by dotted lines in FIG. 3 represent paths and states on which a transition is not made when conducting reproduction processing on media having the shortest mark length 3T on the recording face of the disk, such as a CD or a DVD. FIG. 4 is a trellis diagram obtained by transforming the state transition diagram shown in FIG. 3. FIG. 4 shows how state transitions are made over three time points ranging from time (n−2)T (where n is a natural number) to time nT based upon timing of the channel clock. In the same way as FIG. 3, parts indicated by dotted lines represent paths and states on which a transition is not made when conducting reproduction processing on a CD or DVD. S0000 to S1111 represent transition states, and BM00000(n) to BM11111(n) represent branch metrics. The branch metrics are calculated by the following equations.

BM00000(n)=(reproduced signal(n)−REF00000) (Equation 1-1)

BM00001(n)=(reproduced signal(n)−REF00001) (Equation 1-2)

BM00011(n)=(reproduced signal(n)−REF00011) (Equation 1-3)

BM00110(n)=(reproduced signal(n)−REF00110) (Equation 1-4)

BM00111(n)=(reproduced signal(n)−REF00111)2 (Equation 1-5)

BM01100(n)−(reproduced signal(n)−REF01100) (Equation 1-6)

BM01110(n)−(reproduced signal(n)−REF01110) (Equation 1-7)

BM01111(n)=(reproduced signal(n)−REF01111) (Equation 1-8)

BM10000(n)=(reproduced signal(n)−REF10000) (Equation 1-9)

BM10001(n)=(reproduced signal(n)−REF10001) (Equation 1-10)

BM10011(n)=(reproduced signal(n)−REF10001) (Equation 1-11)

BM11000(n)=(reproduced signal(n)−REF11000) (Equation 1-12)

BM11001(n)−(reproduced signal(n)−REF11001) (Equation 1-13)

BM11100(n)−(reproduced signal(n)−REF11100) (Equation 1-14)

BM11110(n)−(reproduced signal(n)−REF11110) (Equation 1-15)

BM11111(n)−(reproduced signal(n)−REF11111) (Equation 1-16)

In the equations, (n) represents a value at time nT. The maximum likelihood decision of Viterbi decoding is implemented by comparing likelihoods in a state in which two paths meet each other and selecting a path having a higher likelihood. Likelihoods called path metrics and the above-described branch metrics are used in the maximum likelihood decision. The path metric is a total sum of branch metrics corresponding to paths between which transitions have been made until the current time is reached. Path metrics PM0000(n) to PM1111(n) are calculated by the following equations. Furthermore, min {*, *, . . . , *} represents a function which selects a minimum value from among values indicated in { }.

PM0000(n)=min{PM0000(n−1)+BM00000(n),PM1000(n−1)+BM10000(n)} (Equation 1-17)

PM0001(n)=min{PM0000(n−1)+BM00001(n),PM1000(n−1)+BM10001(n)} (Equation 1-18)

PM0011(n)=min{PM0001(n−1)+BM00011(n),PM1001(n−1)+BM10011(n)} (Equation 1-19)

PM0110(n)=PM0011(n−1)+BM00110(n) (Equation 1-20)

PM0111(n)=PM0011(n−1)+BM00111(n) (Equation 1-21)

PM1000(n)=PM1100(n−1)+BM11000(n) (Equation 1-22)

PM1001(n)=PM1100(n−1)+BM11001(n) (Equation 2-23)

PM1100(n)=min{PM0110(n−1)+BM01100(n),PM1110(n−1)+BM11100(n)} (Equation 1-24)

PM1110(n)=min{PM0111(n−1)+BM01110(n),PM1111(n−1)+BM11110(n)} (Equation 1-25)

PM1111(n)=min{PM0111(n−1)+BM01111(n),PM1111(n−1)+BM11111(n)} (Equation 1-26)

In the equations, (n) represents a value at time nT. In the same way, (n−1) represents a value at time (n−1)T. Contents indicated by (Equation 1-17) to (Equation 1-26) are that the path metric is updated to cause a new path metric to become a result obtained by adding up an old path metric of one time period before and a branch metric at the current time. Furthermore, in a state in which two paths meet each other, two addition results are compared with each other and a path having a smaller value is selected as a path having a higher likelihood. Paths having higher likelihoods are gradually selected by repeating the maximum likelihood decision using these path metrics every time a reproduced signal is input. A decoding result is obtained by tracing paths which have survived finally.

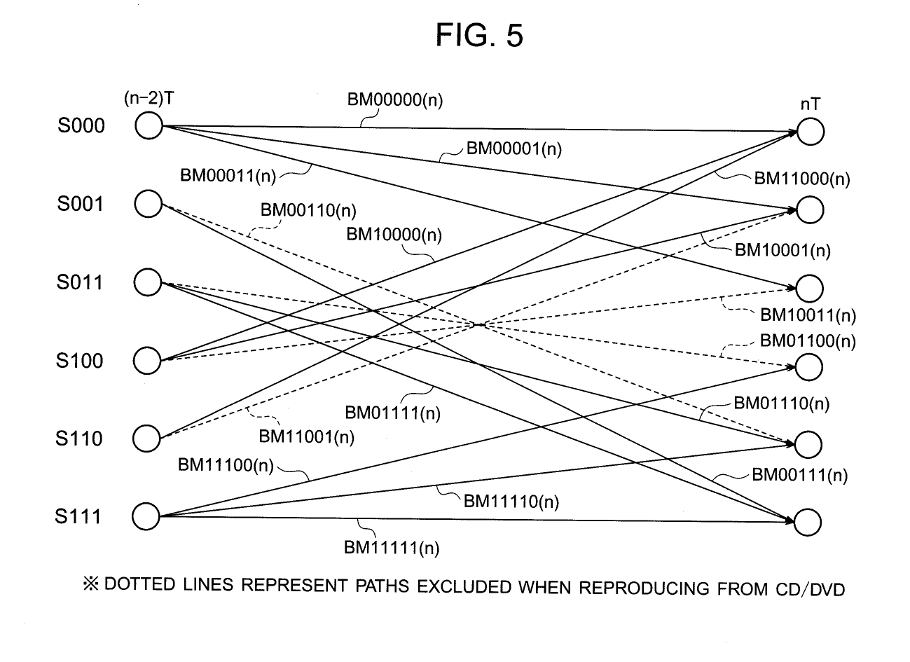

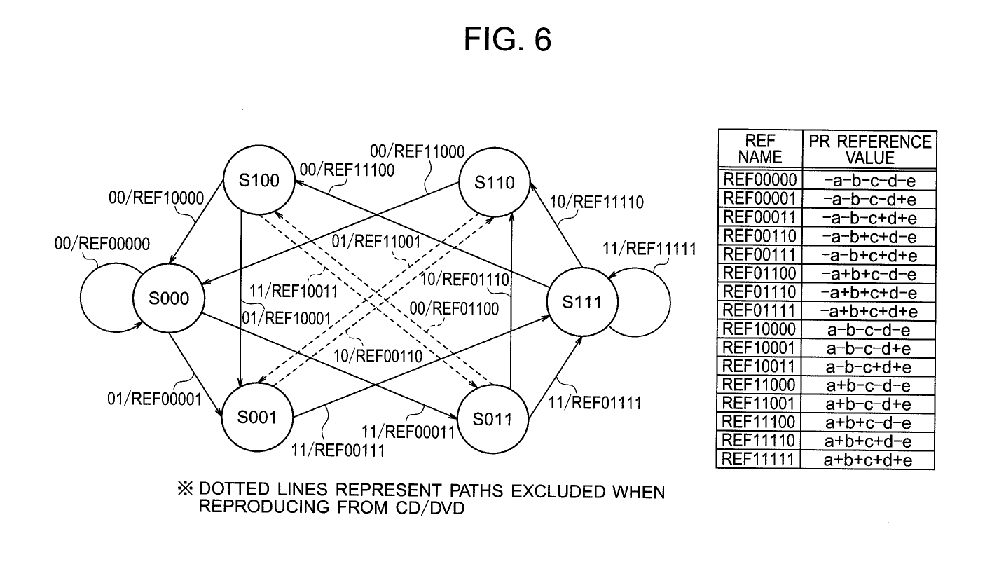

FIG. 5 shows a trellis diagram of PR(a, b, c, d, e) having a restraint length of 5 in the case where the shortest mark length on the recording face of the disk is 2T in Viterbi decoding corresponding to a reproduced signal sampled with the half clock in the present embodiment. Parts indicated by dotted lines in FIG. 5 represent paths on which a transition is not made when conducting reproduction processing on media having the shortest mark length 3T on the recording face of the disk, such as a CD or a DVD, in the same way as FIG. 4. In FIG. 5, a reproduced signal sampled with the half clock is input. Denoting by using time based upon the channel clock, therefore, the time (n−1)T is thinned and state transitions over two time points ranging from the time (n−2)T to the time nT are shown. In FIG. 5, S000 to S111 represent transition states, and it is appreciated that the number of transition states is decreased as compared with FIG. 4. This is because different transition states in FIG. 4 can be made to degenerate by conducting sampling with the half clock. For example, attention is paid to a path (hereafter referred to as path A_{ch}) on which transitions S0000→S0001→S0011 are made and a path (hereafter referred to as path B_{ch}) on which transitions S1000→S0001→S0011 are made. In the case where sampling is conducted with the half clock, the state transition at the time (n−1)T is eliminated and consequently the path A_{ch} becomes a path (hereafter referred to as path A_{half}) on which a direct transition from S0000 to S0011 is made and the path B_{ch} becomes a path (hereafter referred to as path B_{half}) on which a direct transition from S1000 to S0011 is made. At this time, a PR reference value referred to in the transition of the path A_{half} becomes REF00011. On the other hand, a PR reference value referred to in the transition of the path B_{half} also becomes REF00011. Therefore, branch metrics of the two paths become BM00011 and equal to each other. As a result, one left bit in S**** which represents the state can be omitted because it does not affect the state transition. And it becomes possible to newly represent the path A_{half} and the path B_{half} collectively as a path on which a transition S000→S011 is made. Transformation to the trellis diagram shown in FIG. 5 is conducted by conducting the above-described manipulation in respective states. FIG. 6 is obtained by representing the trellis diagram shown in FIG. 5 as a state transition diagram. Parts indicated by dotted lines in FIG. 6 represent paths on which a transition is not made when conducting reproduction processing on media having the shortest mark length 3T on the recording face of the disk, such as a CD or a DVD, in the same way as FIG. 3. In Viterbi decoding corresponding to the reproduced signal sampled with the half clock, decoding of two bits is conducted every state transition as shown in FIG. 6. Branch metrics BM00000(n) to BM11111(n) are calculated according to (Equation 1-1) to (Equation 1-16), and path metrics are calculated according to the following equations.

PM000(n)=min{PM000(n−2)+BM00000(n),PM100(n−2)+BM10000(n),PM110(n−2)+BM11000(n)} (Equation 1-27)

PM001(n)=min{PM000(n−2)+BM00001(n),PM100(n−2)+BM10001(n),PM110(n−2)+BM11001(n)}(Equation 1-28)

PM011(n)=min{PM000(n−2)+BM00011(n),PM100(n−2)+BM10011(n)} (Equation 1-29)

PM100(n)=min{PM011(n−2)+BM01100(n),PM111(n−2)+BM11100(n)} (Equation 1-30)

PM110(n)=min{PM001(n−2)+BM00110(n),PM011(n−2)+BM01110(n),PM111(n−2)+BM11110(n)} (Equation 1-31)

PM111(n)=min{PM001(n−2)+BM00111(n),PM011(n−2)+BM01111(n),PM111(n−2)+BM11111(n)} (Equation 1-32)

In the equations, (n) represents a value at time nT. In the same way, (n−2) represents a value at time (n−2)T. Contents indicated by (Equation 1-27) to (Equation 1-32) are that the path metric is updated to cause a new path metric to become a result obtained by adding up an old path metric of two time periods before and a branch metric at the current time. Furthermore, in a state in which a plurality of paths meet, addition results are compared and a path having a smallest value is selected as a path having a high likelihood. Paths having high likelihoods are gradually selected by repeating the maximum likelihood decision using these path metrics every time a reproduced signal is input. A decoding result is obtained by tracing paths which have survived finally.

Operation contents of the Viterbi decoder 108 in the information reproduction apparatus according to the present embodiment will now be described in detail. As shown in FIG. 1, the Viterbi decoder 108 includes a BMC (Branch Metric Calculator) 109, an ACS (Add Compare Select) 110, a PM (Path Metric) memory 111, and a path memory 112. The BMC 109 calculates branch metrics BM00000(n) to BM11111(n) on the basis of the reproduced signal subjected to waveform equalization in the equalizer 107, and inputs the branch metrics to the ACS 110. The ACS 110 calculates path selection signals SEL000(n) to SEL111(n) at the current time and path metrics PM000(n) to PM111(n) at the current time on the basis of the branch metrics BM00000(n) to BM11111(n) which are input from the BMC109 and path metrics PM000(n−2) to PM111(n−2) of two time periods before which are input from the PM memory 111. The calculated path selection signals SEL000(n) to SEL 111(n) are input to the path memory 112, and the path metrics PM000(n) to PM111(n) at the current time are overwritten in the PM memory 111. The path memory 112 updates path transition state information retained therein, in accordance with the path selection signals SEL000(n) to SEL 111(n) which are input, generates decoding data on the basis of the path transition state information, and inputs the decoding data to the decoder 113.

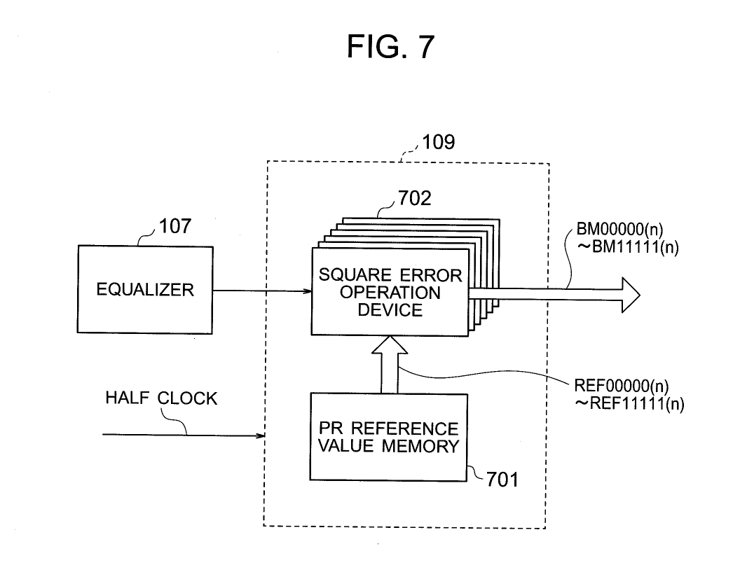

FIG. 7 shows details of the BMC 109 shown in FIG. 1.

In the BMC 109, a square error operation device 702 calculates the branch metrics BM00000(n) to BM11111(n) indicated in (Equation 1-1) to (Equation 1-16) by using the reproduced signal subjected to the waveform equalization in the equalizer 107 and PR reference values REF00000 to REF11111 recorded in a PR reference value memory 701, and outputs the branch metrics BM00000(n) to BM11111(n).

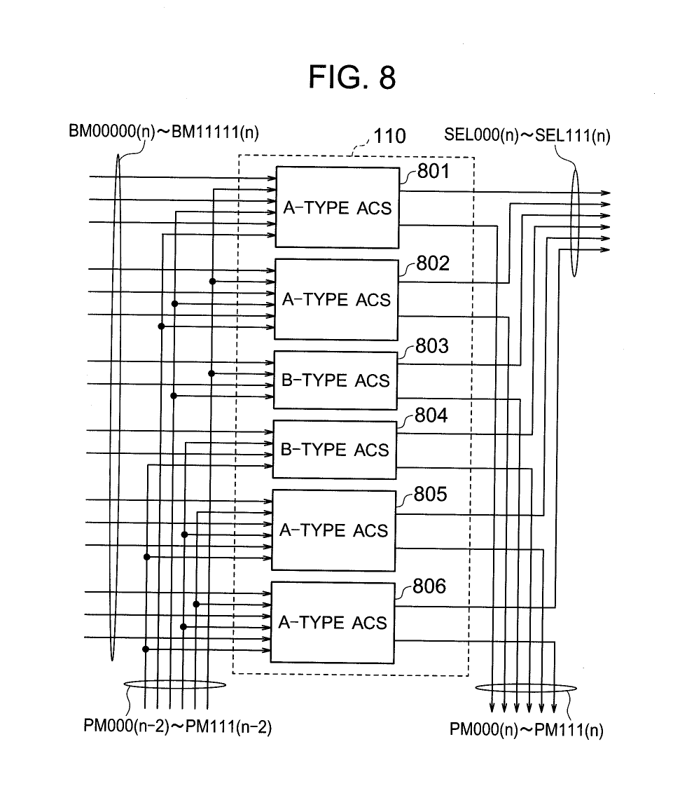

FIG. 8 shows details of the ACS 110 shown in FIG. 1.

In the ACS 110, A-type ACSs 801, 802, 805 and 806 and B-type ACSs 803 and 804 calculate the path selection signals SEL000(n) to SEL111(n) at the current time and the path metrics PM000(n) to PM111(n) at the current time indicated by (Equation 1-27) to (Equation 1-32) by using the branch metrics BM00000(n) to BM11111(n) at the current time calculated by the BMC 109 and the path metrics PM000(n−2) to PM111(n−2) of two time periods before recorded in the PM memory 111. The path metrics PM000(n) to PM111(n) at the current time are overwritten in the PM memory 111, and the path selection signals SEL000(n) to SELI11(n) are output to the path memory 112 in a subsequent stage.

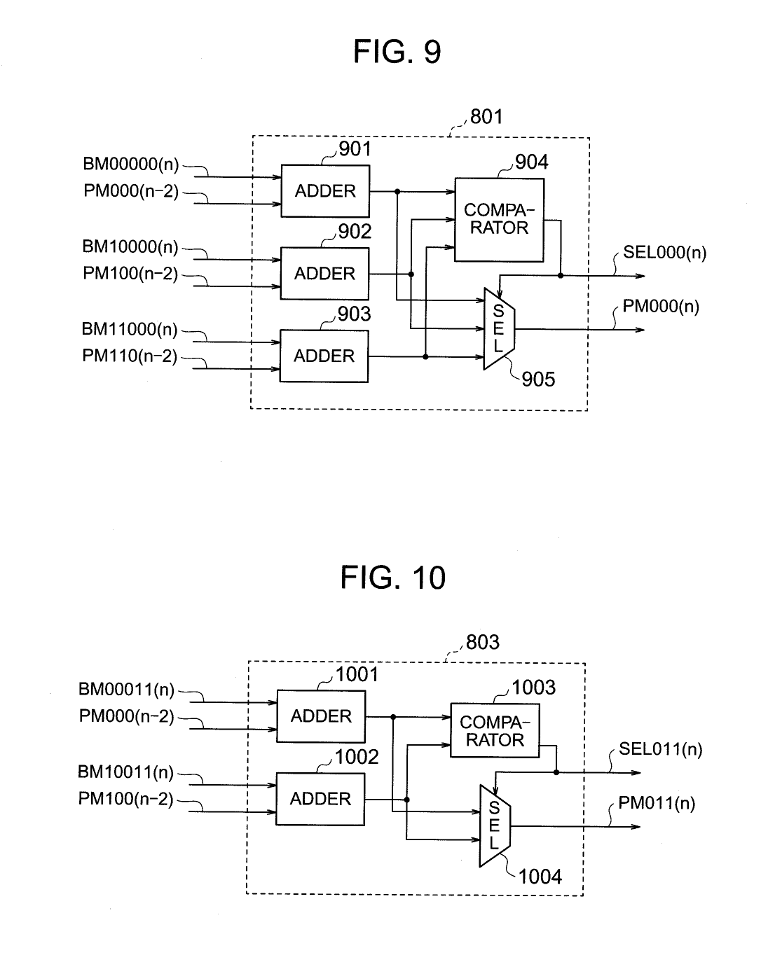

FIG. 9 shows details of the A-type ACS 801 shown in FIG. 8.

The A-type ACS 801 is a circuit which calculates the path metric PM000(n) indicated by (Equation 1-27), and the A-type ACS 801 selects one of three meeting paths as a maximum likelihood path. An adder 901 calculates a metric of a path on which a transition S000→S000 in FIG. 5 is made. In the same way, an adder 902 calculates a metric of a path on which a transition S100→S000 is made, and an adder 903 calculates a metric of a path on which a transition S110→S000 is made. A comparator 904 compares three metrics which are input from the adders 901, 902 and 903, generates the path selection signal SEL000(n) for selecting a path which is minimum in metric value, and inputs the path selection signal SEL000(n) to a selector 905. The selector 905 selects one out of the three metrics on the basis of the path selection signal SEL000(n). A metric value of the selected path is overwritten in the PM memory 111 as the path metric PM000(n), and the path selection signal SEL000(n) is output to the path memory 112 in the subsequent stage.

In the same way as the A-type ACS 801, the A-type ACSs 802, 805 and 806 conduct calculations of (Equation 1-28), (Equation 1-31) and (Equation 1-32), respectively, and generate the corresponding path metrics PM001(n),PM110(n) and PM111(n) and path selection signals SEL001(n), SEL110(n) and SEL111(n), respectively. The path metrics are overwritten in the PM memory 111, and the path selection signals are output to the path memory 112 in the subsequent stage.

FIG. 10 shows details of the B-type ACS 803 shown in FIG. 8.

The B-type ACS 803 is a circuit which calculates the path metric PM011(n) indicated by (Equation 1-29), and the B-type ACS 803 selects one of two meeting paths as a maximum likelihood path. An adder 1001 calculates a metric of a path on which a transition S100→S011 in FIG. 5 is made. In the same way, an adder 1002 calculates a metric of a path on which a transition S100→S011 is made. A comparator 1003 compares two metrics which are input from the adders 1001 and 1002, generates a path selection signal SEL011(n) for selecting a path which is minimum in metric value, and inputs the path selection signal SEL011(n) to a selector 1004. The selector 1004 selects one out of the two metrics on the basis of the path selection signal SEL011(n). A metric value of the selected path is overwritten in the PM memory 111 as the path metric PM011(n), and the path selection signal SEL011(n) is output to the path memory 112 in the subsequent stage.

In the same way as the B-type ACS 803, the B-type ACS 804 conducts the calculation of (Equation 1-30) and generates the path metric PM100(n) and a path selection signal SEL100(n). The path metric is overwritten in the PM memory 111, and the path selection signal is output to the path memory 112 in the subsequent stage.

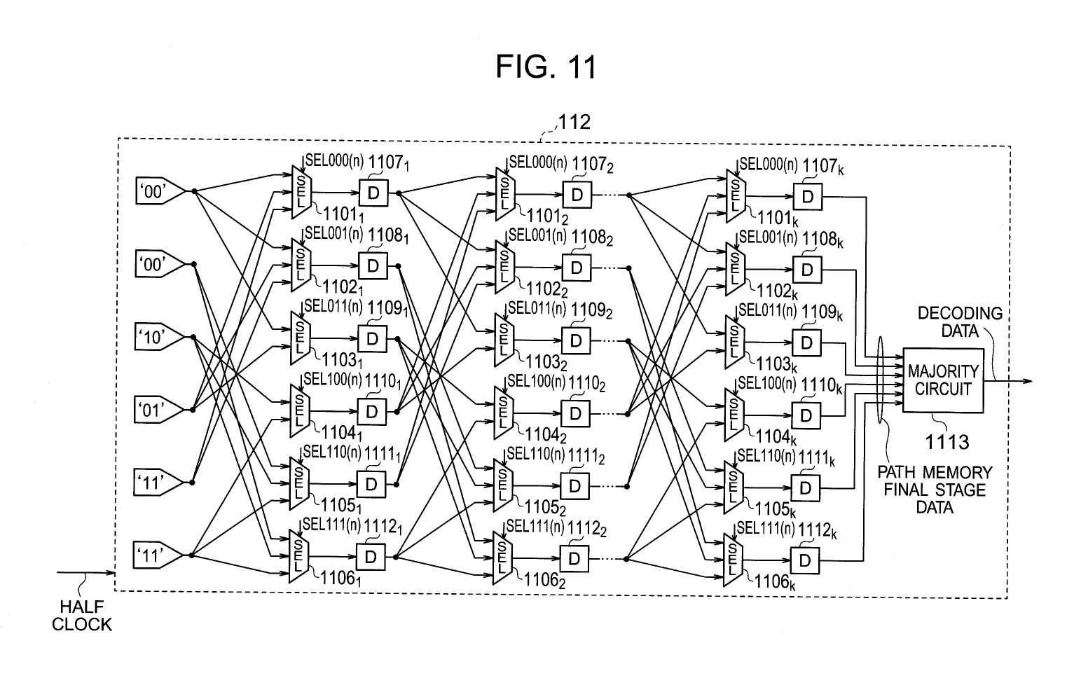

FIG. 11 shows details of the path memory 112 shown in FIG. 1.

Selectors 1101₁ to 1106₁, 1101₂ to 1106₂, and 1101ₖ to 1106ₖ select one out of a plurality of inputs on the basis of the path selection signals SEL000(n) to SEL111(n) which are input from the ACS 110, and store the selected inputs into delay circuits 1107₁ to 1112₁, 1107₂ to 1112₂, and 1107ₖ to 1112ₖ, respectively. In FIG. 11, k represents the number of transition stages of transition state information recorded in the path memory. Although k may be set arbitrarily, a larger value of k raises the decoding precision, prolongs the delay, and makes the circuit scale larger. If surviving paths at a time reached when going back to the past by 2(k−1)T from the current time in Viterbi decoding processing are determined to be one, all values of the delay circuits 1107ₖ to 1112ₖ coincide with each other and that value becomes decoding data as it is. If a plurality of surviving paths exist, however, then values of the delay circuits 1107ₖ to 1112ₖ do not coincide with each other and it is necessary to make a decision as to decoding data on the basis of those values. As an example of a decision method, decision processing based upon majority is used. A majority circuit 1113 conducts decision processing based upon majority using final stage data of the path memory which are input from the delay circuits 1107ₖ to 1112ₖ, and outputs decoding data. By the way, in the present embodiment, decision processing based upon majority is used as the decision method for decoding data. However, other methods such as decision processing based upon trace back may be used.

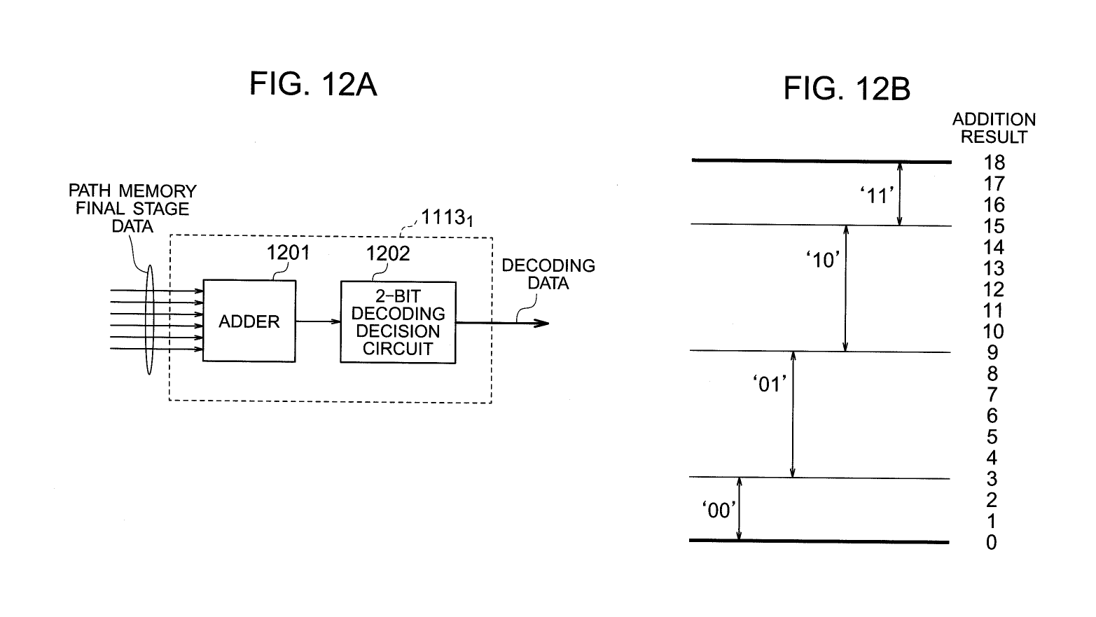

FIGS. 12A and 12B show a first configuration example of the majority circuit 1113 shown in FIG. 11.

In FIG. 12A, 2-bit path memory final stage data which are input to a majority circuit 1113₁ are added up by an adder 1201, and a result of the addition is input to a 2-bit decoding decision circuit 1202. The 2-bit decoding decision circuit 1202 makes a decision as to a decoding result on the basis of the addition result which is input thereto, and outputs decoding data of 2 bits. FIG. 12B shows an example of a decision method in the 2-bit decoding decision circuit 1202. When the addition result is less than 3, the decoding data is set to ‘00.’ When the addition result is at least 3 and less than 9, the decoding data is set to ‘01.’ When the addition result is at least 9 and less than 15, the decoding data is set to ‘10.’ When the addition result is at least 15, the decoding data is set to ‘11.’ In this way, a decision is made. Thresholds for this decision may be set arbitrarily. As another example of the threshold setting method, a method of previously finding respective existence frequencies of ‘00, “01,” 10,’ and ‘11” and setting thresholds to widen the decision range of a code string having a high frequency can be mentioned.

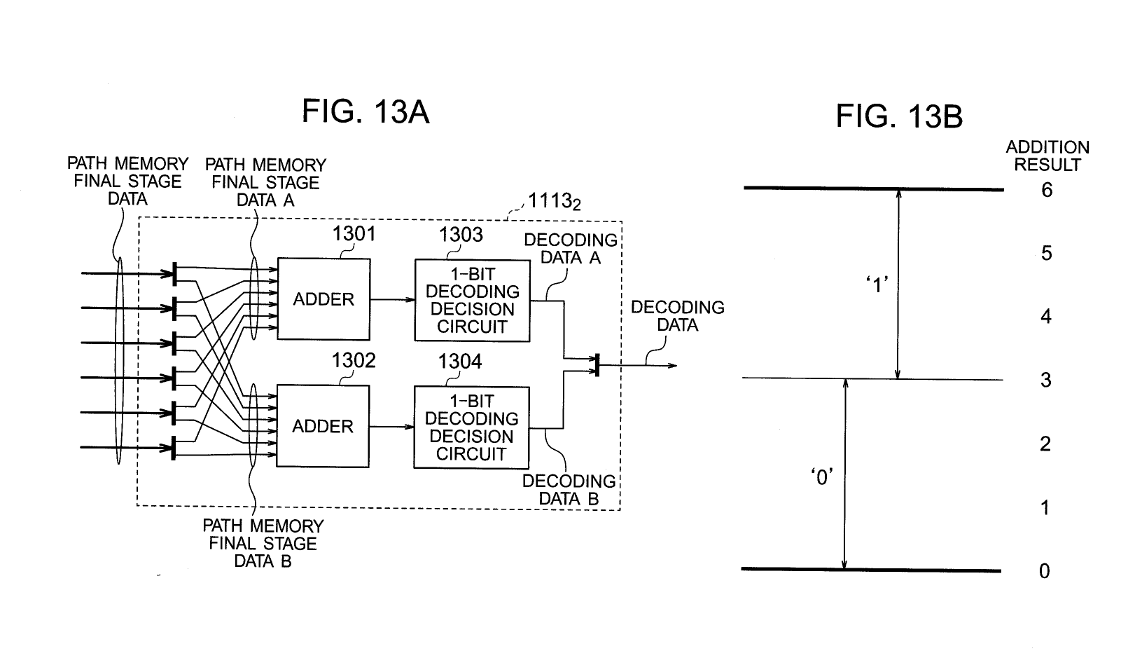

FIGS. 13A and 13B show a second configuration example of the majority circuit 1113 shown in FIG. 11.

In FIG. 13A, the path memory final stage data of 2 bits which is input to a majority circuit 1113₂ is bit-divided into path memory final stage data A which is a high-order bit and path memory final stage data B which is a low-order bit, and the path memory final stage data A and the path memory final stage data B are input to adders 1301 and 1302, respectively. Addition results from the adders 1301 and 1302 are input to 1-bit decoding decision circuits 1303 and 1304, respectively. The 1-bit decoding decision circuits 1303 and 1304 make a decision as to the decoding result on the basis of the addition result which is input, and output decoding data A of a high-order bit and decoding data B of a low-order bit, respectively. Here, the decoding data A represents 1-bit decoding data of one time period before as compared with the decoding data B. The decoding data A and the decoding data B are bit-combined, and a result is output as 2-bit decoding data. FIG. 13B shows an example of a decision method in the 1-bit decoding decision circuits 1303 and 1304. The decoding data A or the decoding data B is decided to be ‘0’ when the addition result is less than 3, and it is decided to be ‘1’ when the addition result is at least 3. By the way, the threshold for this decision may be set arbitrarily.

If the Viterbi decoding corresponding to the half clock sampling described heretofore is used, then it is possible to make the Viterbi decoder operate at timing according to the half clock, with respect to the reproduced signal sampled with the half clock, and it becomes possible to reduce the power consumption of the Viterbi decoder. Furthermore, a circuit in a stage preceding the Viterbi decoder, such as, for example, the waveform equalizer can be operated at timing according to the half clock, and it becomes possible to reduce power consumption of the whole PRML signal processor including the Viterbi decoder.

By the way, in the foregoing description, the partial response is described by using variables as represented by PR(a, b, c, d, e). Each of the variables may be either of an adaptively changed value and a fixed value. Furthermore, the restraint length of the PRML is not restricted to the described length, either. Furthermore, in the foregoing description, the operation clock is set to the half clock oscillating with a frequency which is half of that of the channel clock. However, a frequency obtained by conducting frequency division with an arbitrary value on the channel clock may be used. These descriptions are not restricted to the information reproduction apparatus according to the first embodiment, but similar rereading is possible in the same way in ensuing embodiments as well.

### Embodiment 2

The present embodiment is an embodiment capable of improving in the lowering of the decoding precision in Viterbi decoding corresponding to half clock sampling.

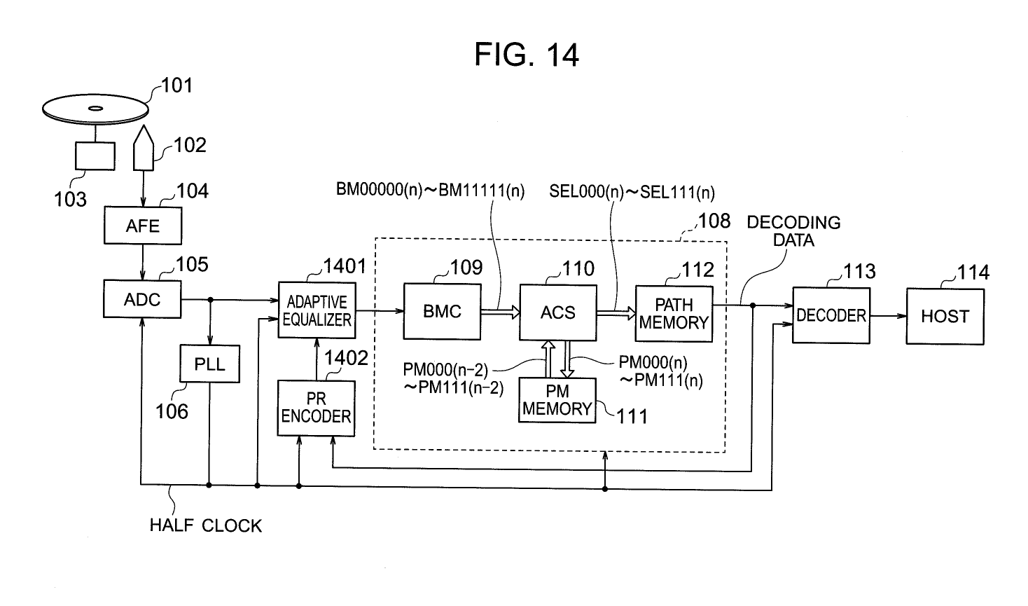

FIG. 14 is a configuration diagram of an information reproduction apparatus according to the embodiment 3 of the present invention. FIG. 14 differs from FIG. 1 showing the information reproduction apparatus according to the embodiment 1 in that an adaptive equalizer 1401 and a PR encoder 1402 are provided. The same reference numeral as that in FIG. 1 denotes a component which is like that in the embodiment 1, and its description will be omitted. As shown in FIG. 14, a signal subjected to waveform equalization in the adaptive equalizer 1401 is subject to decoding processing in the Viterbi decoder 108 and decoding data is input to the decoder 113 and the PR encoder 1402. The decoding data subjected to PR coding in the PR encoder 1402 is fed back to the adaptive equalizer 1401, and it becomes a equalization target value when conducting adaptive equalization processing. An algorithm used in the adaptive equalization processing is an LMS (Least Mean Square) algorithm and an MSE (Means Square Error) algorithm.

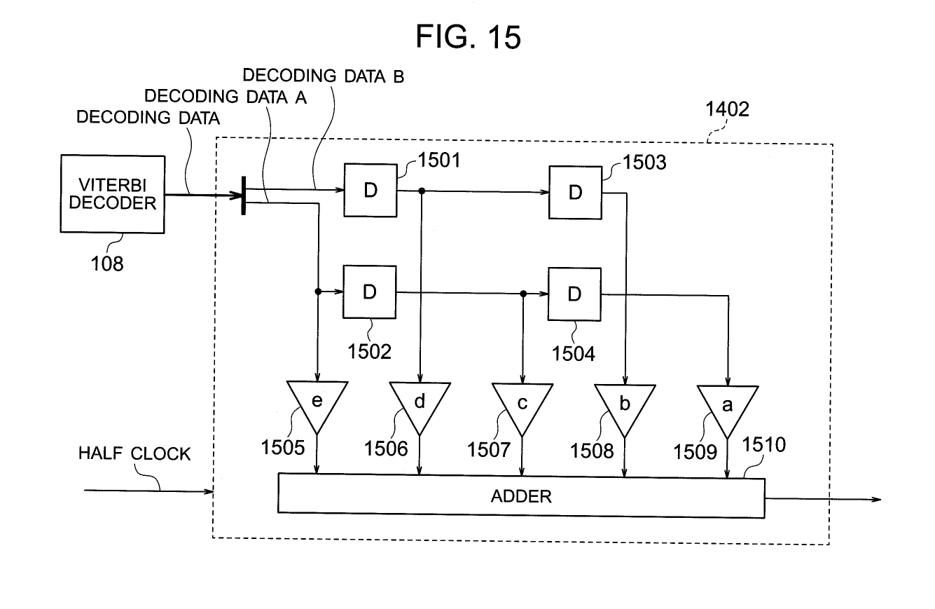

FIG. 15 shows details of the PR encoder 1402 shown in FIG. 14.

The 2-bit decoding data which is input from the Viterbi decoder 108 to the PR encoder 1402 is bit-divided into decoding data A of a high-order bit and decoding data B of a low-order bit. The decoding data A and the decoding data B are input to delay circuits 1501 and 1502, respectively. Here, the decoding data A represents 1-bit decoding data of one time period before as compared with the decoding data B. Outputs from the delay circuits 1501 and 1502 are input to delay circuits 1503 and 1504, respectively. As shown in FIG. 15, outputs of the Viterbi decoder 108, and the delay circuits 1501, 1502, 1503 and 1504 are input to an e-times multiplier 1505, a d-times multiplier 1506, a c-times multiplier 1507, a b-times multiplier 1508, and an a-times multiplier 1509, respectively. Outputs of these multipliers are input to an adder 1510, and an addition result is output from the adder 1510. Here, a, b, c, d and e are variables corresponding to values indicated by PR(a, b, c, d, e). In the present embodiment, the adaptive equalizer 1401 and the PR encoder 1402 are provided with configurations corresponding to operation at timing according to the half clock. Alternatively, however, a method of down-sampling the output of the adaptive equalizer 1401 may be used in configurations corresponding to operation at timing according to the channel clock.

In the case where sampling is conducted at timing according to the half clock, the number of meeting paths which become maximum likelihood path candidates increases from 2 in the conventional art to 3 and a higher precision in the amplitude direction of the reproduced signal is required of selection processing, and consequently decoding errors are apt to increase, resulting in a lowered decoding precision. If Viterbi decoding corresponding to the half clock sampling with adaptive equalization processing described heretofore introduced is used, however, it is possible to conduct waveform equalization adaptively to make the reproduced signal amplitude approach characteristics of the PR reference value and improve the decoding precision.

By the way, the circuit configuration using the adaptive equalization scheme described heretofore is not restricted to the present embodiment, but it may be suitably applied to other embodiments as well.

### Embodiment 3

The present embodiment is an embodiment capable of changing over between Viterbi decoding corresponding to the half clock sampling and Viterbi decoding corresponding to the conventional channel clock sampling.

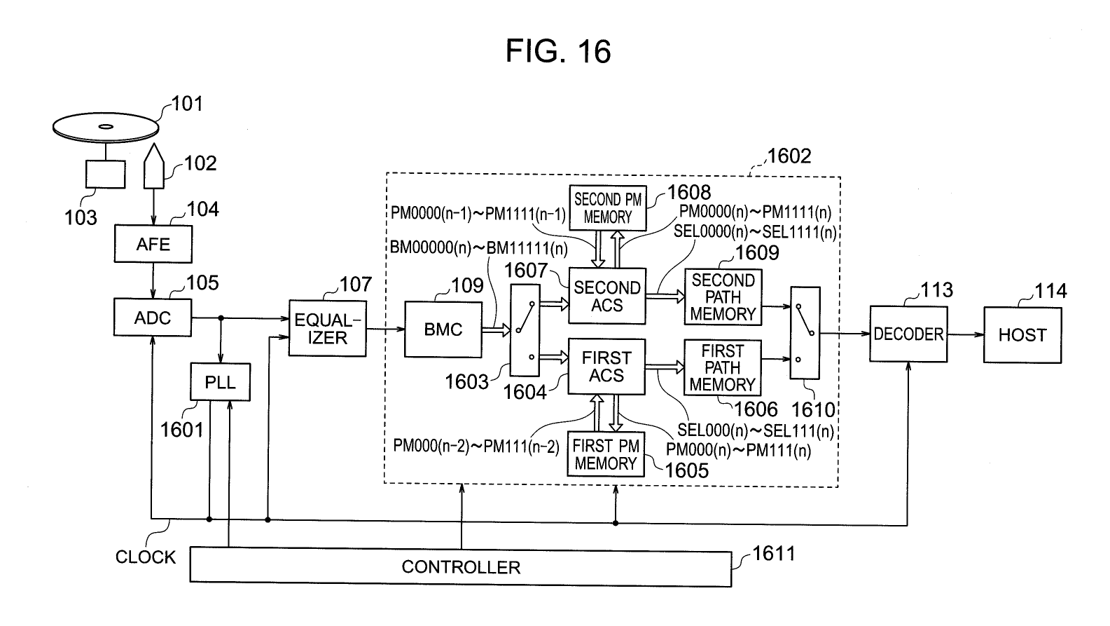

FIG. 16 is a configuration diagram of an information reproduction apparatus according to the embodiment 3 of the present invention. FIG. 16 differs from FIG. 1 showing the information reproduction apparatus according to the embodiment 1 in that a PLL 1601, a Viterbi decoder 1602, a switch 1603, a first ACS 1604, a first PM memory 1605, a first path memory 1606, a second ACS 1607, a second PM memory 1608, a second path memory 1609, a switch 1610, and a controller 1611 are provided. The same reference numeral as that in FIG. 1 denotes a component which is like that in the embodiment 1, and its description will be omitted. Furthermore, the first ACS 1604, the first PM memory 1605, and the first path memory 1605 have the same configuration as that of the ACS 110, the PM memory 111, and the path memory 112 in FIG. 1, respectively, and description of them will be omitted.

As shown in FIG. 16, the PLL 1601 generates a channel clock synchronized to a digitized reproduced signal and a half clock which oscillates with a frequency which is half of that of the channel clock, selects the channel clock or the half clock on the basis of control from the controller 1611, and inputs the selected channel clock or half clock to the ADC 105, the equalizer 107, the Viterbi decoder 1602, and the decoder 113. A clock shown in FIG. 16 represents the channel clock at the time of channel clock sampling, and represents the half clock at the time of half clock sampling. The switch 1603 inputs branch metrics BM00000(n) to BM11111(n) (where n is a natural number) which are input from the BMC 109, to the first ACS 1604 at the time of half clock sampling and to the second ACS 1607 at the time of channel clock sampling on the basis of control from the controller 1611. By the way, BM00000(n) to BM11111(n) are calculated according to (Equation 1-1) to (Equation 1-16). The second ACS 1607 calculates path selection signals SEL0000(n) to SEL1111(n) at the current time and the path metrics PM0000(n) to PM1111(n) at the current time expressed by (Equation 1-17) to (Equation 1-26) on the basis of the branch metrics BM00000(n) to BM11111(n) which are input and path metrics PM0000(n−1) to PM1111(n−1) of one time period before which are input from the second PM memory 1608. The calculated path selection signals SEL0000(n) to SEL1111(n) are input to the second path memory 1609, and the path metrics PM0000(n) to PM1111(n) at the current time are overwritten in the second PM memory 1608. The second path memory 1609 updates path transition state information retained therein on the basis of the path selection signals SEL0000(n) to SEL1111(n) which are input, generates decoding data on the basis of the path transition state information, and inputs the generated decoding data to the switch 1610. On the basis of control from the controller 1611, the switch 1610 selects an output of the first path memory 1606 at the time of the half clock sampling, selects an output of the second path memory 1609 at the time of channel clock sampling, and inputs the selected output to the decoder 113.

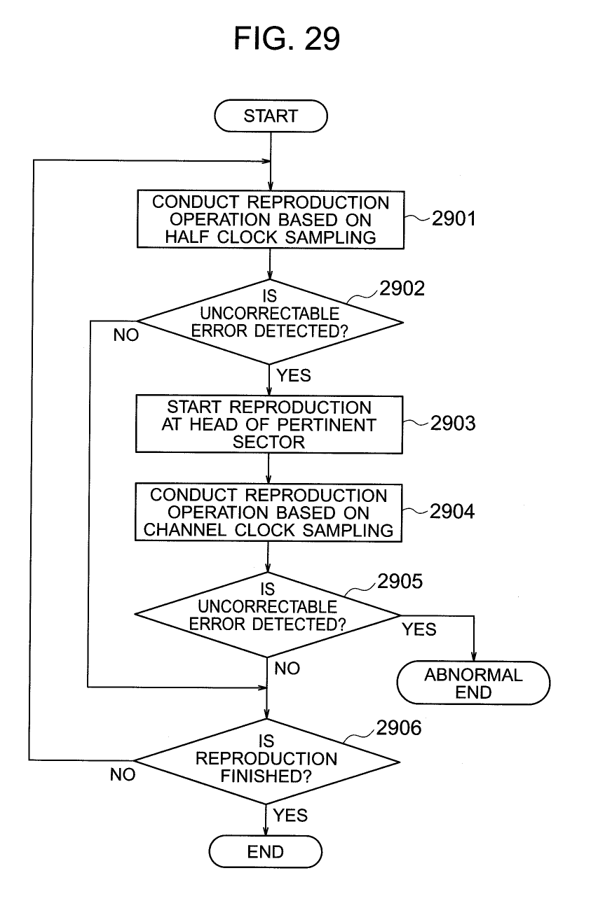

The controller 1611 exercises control changeover processing between the channel clock sampling and the half clock sampling. Hereafter, an example of the changeover processing in the present embodiment will be described. FIG. 29 shows a procedure of the changeover processing at the time of retry operation. First of all, reproduction operation using the half clock sampling is conducted (2901). Normally, this operation is maintained. If an uncorrectable error is detected in the error corrector 2802, however, ensuing processing is executed (2902). After moving to a head of a sector having the detected uncorrectable error, a shift to a retry operation is conducted to execute reproduction again (2903). However, the half clock sampling is changed over to the channel clock sampling and reproduction in the retry operation is executed (2904). If generation of an uncorrectable error is prevented by the retry operation (2905), the channel clock sampling is changed over to the half clock sampling again and normal reproduction is executed until reproduction is finished (2906). Alternatively, a decision as to changeover may be made in response to a double speed operation, or a decision as to changeover may be made on the basis of a discriminated kind of the disk. Or the user may previously select the operation of the channel clock sampling or the half clock sampling and set it.

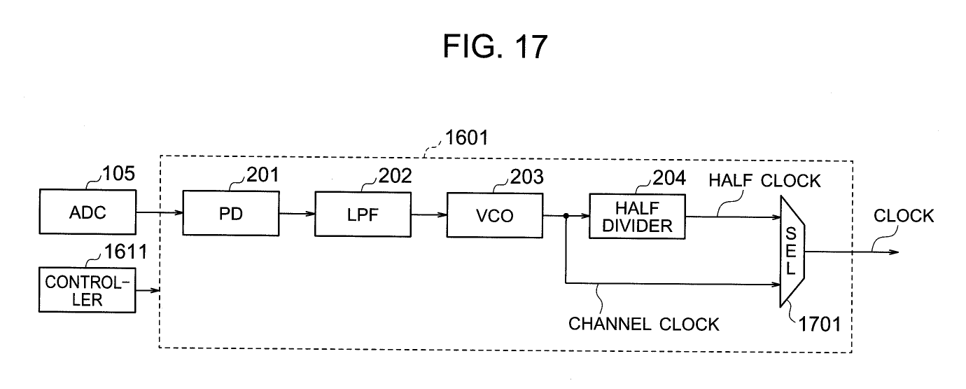

FIG. 17 shows an example of a configuration of the PLL 1601 shown in FIG. 16. FIG. 17 differs from FIG. 2 showing an example of the configuration of the PLL 106 in the embodiment 1 in that a controller 1611 and a selector 1701 are provided. The same reference numeral as that in FIG. 2 denotes a component which is like that in the embodiment 1, and its description will be omitted. The channel clock generated by the VCO 23 and the half clock generated by the half divider 204 are input to the selector 1701. The selector 1701 selects one out of the half clock and the channel clock on the basis of control from the controller 1611, and outputs the selected clock.

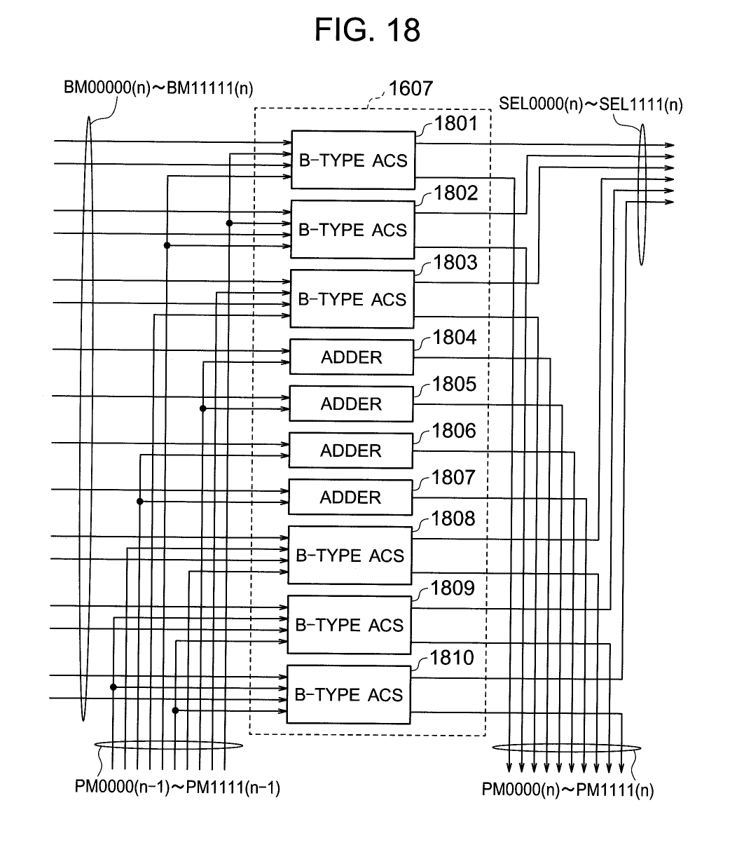

FIG. 18 shows details of the second ACS 1607 shown in FIG. 16.

The second ACS 1607 calculates path selection signals SEL0000(n) to SEL1111(n) at the current time and the path metrics PM0000(n) to PM1111(n) at the current time expressed by (Equation 1-17) to (Equation 1-26) on the basis of the branch metrics BM00000(n) to BM11111(n) at the current time calculated by the BMC 109 and the path metrics PM0000(n−1) to PM1111(n−1) of one time period before which are recorded in the second PM memory 1608, by using B-type ACSs 1801, 1802, 1803, 1808, 1809, and 1810 and adders 1804, 1805, 1806, and 1807. The path metrics PM0000(n) to PM1111(n) at the current time are overwritten in the second PM memory 1608, and the path selection signals SEL0000(n) to SEL1111(n) are output to the second path memory 1609 in the subsequent stage.

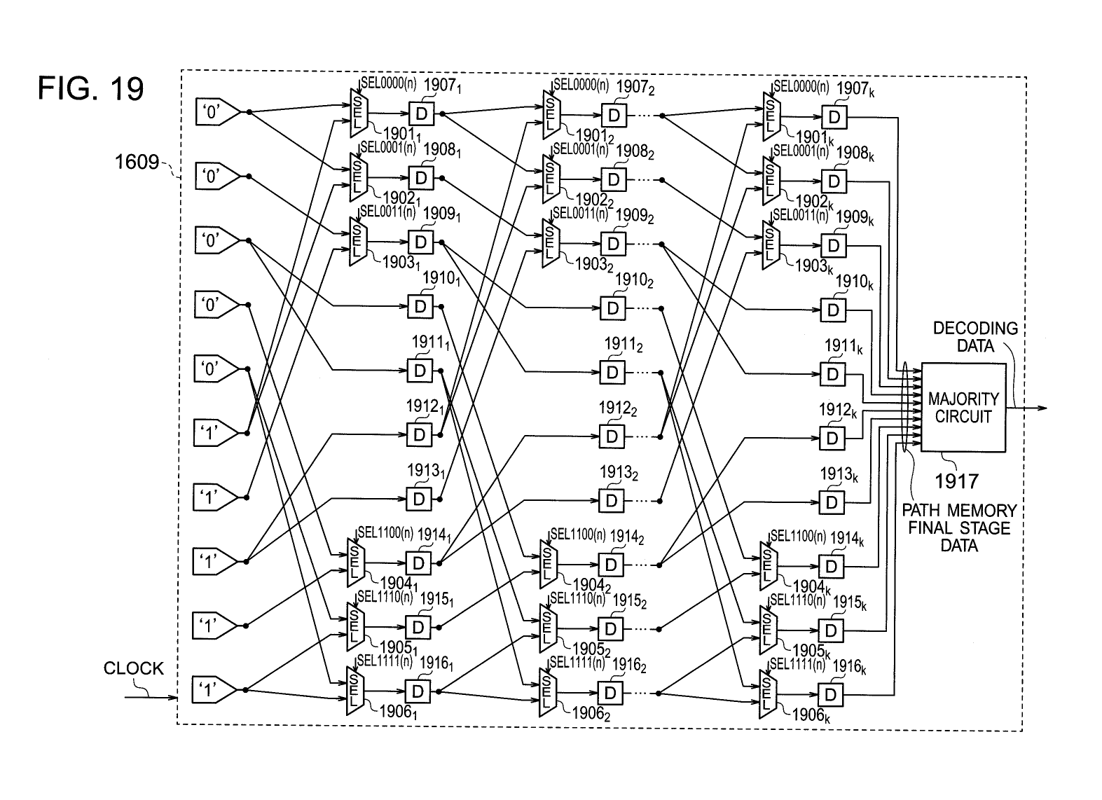

FIG. 19 shows details of the second path memory 1609 shown in FIG. 16.

Selectors 1901₁ to 1906₁, 1901₂ to 1906₂, and 1901ₖ to 1906ₖ select one out of a plurality of inputs on the basis of the path selection signals SEL0000(n) to SEL1111(n) which are input from the second ACS 1607, and stores it in delay circuits 1907₁ to 1909₁ and 1914₁ to 1916₁, delay circuits 1907₂ to 1909₂ and 1914₂ to 1916₂, and delay circuits 1907ₖ to 1909ₖ and 1914ₖ to 1916ₖ, respectively. In FIG. 19, k indicates the number of transition stages of transition state information recorded in the path memory. A majority circuit 1917 conducts decision processing based upon majority on 1-bit data by using path memory final stage data which are input from the delay circuits 1907ₖ to 1916ₖ, and outputs decoding data.

If the Viterbi decoding coping with both the half clock sampling and the channel clock sampling described heretofore is used, it becomes possible to change over to suitable Viterbi decoding according to the quality of the reproduced signal. For example, it becomes possible to reduce power consumption by applying Viterbi coding corresponding to the half clock sampling if distortion and noise contained in the reproduced signal from the optical disk are slight (for example, when reproducing from a high quality disk) and assure the decoding precision by changing over to the Viterbi decoding corresponding to the channel clock sampling if distortion and noise contained in the reproduced signal is much (for example, when reproducing from a coarse disk). The present embodiment has a configuration in which an operation unit of Viterbi decoding corresponding to the channel clock sampling is made to operate with the channel clock. Alternatively, however, the operation unit of Viterbi decoding corresponding to the channel clock sampling may be formed of two operation units operating with the half clock connected in parallel.

By the way, the changeover decision method and the setting method of the channel clock sampling and the half clock sampling are not restricted to the present embodiment, but may be applied to embodiments described hereafter.

Furthermore, the partial response in the above-described Viterbi decoding may be either of an adaptively changed value and a fixed value. Furthermore, the restraint length of the PRML is not restricted to the described length, either. In the foregoing description, it is supposed as an embodiment that the operation clock is the half clock oscillating with a frequency which is half of that of the channel clock. Alternatively, however, a frequency obtained by applying frequency division with an arbitrary value to the channel clock may be used.

### Fourth Embodiment

The present embodiment is an embodiment capable of changing over between Viterbi decoding corresponding to the half clock sampling and Viterbi decoding in which decoding processing is conducted on a reproduced signal sampled with the channel clock, at timing according to the half clock.

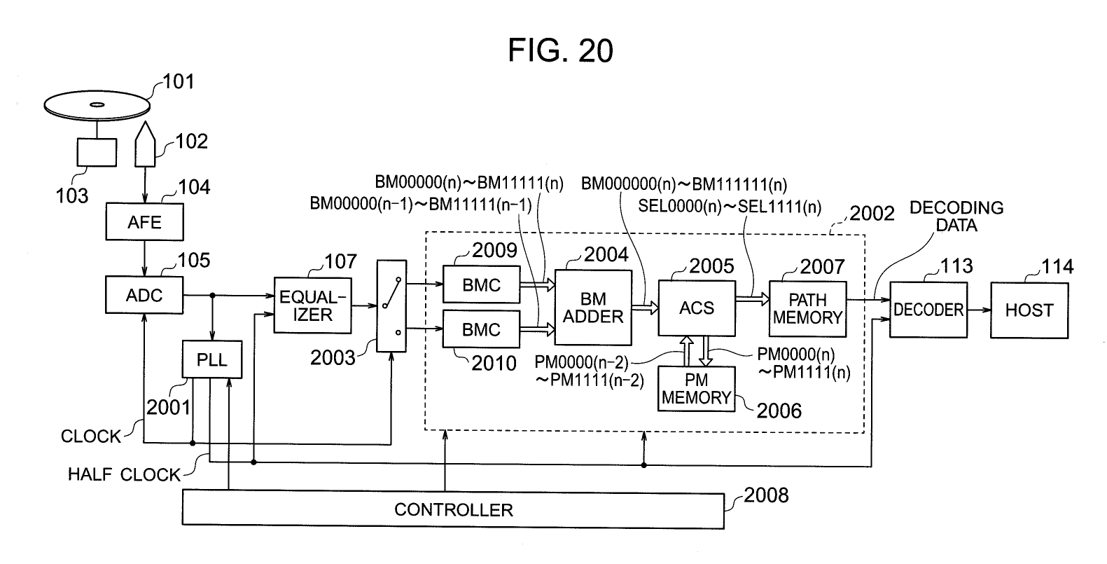

FIG. 20 is a configuration diagram of an information reproduction apparatus according to a fourth embodiment of the present invention. FIG. 20 differs from FIG. 1 showing the information reproduction apparatus according to the embodiment 1 in that a PLL 2001, a Viterbi decoder 2002, a switch 2003, a BM (Branch Metric) adder 2004, an ACS 2005, a PM memory 2006, a path memory 2007, a controller 2008, and BMCs 2009 and 2010 are provided. The same reference numeral as that in FIG. 1 denotes a component which is like that in the embodiment 1, and its description will be omitted. Furthermore, the BMs 2009 and 2010 have the same configuration as that of the BMC 109 in FIG. 1, and description of them will be omitted.

An outline of Viterbi decoding in which decoding processing is conducted on a reproduced waveform sampled with the channel clock synchronized to a reproduced signal, at timing according to the half clock will now be described in detail.

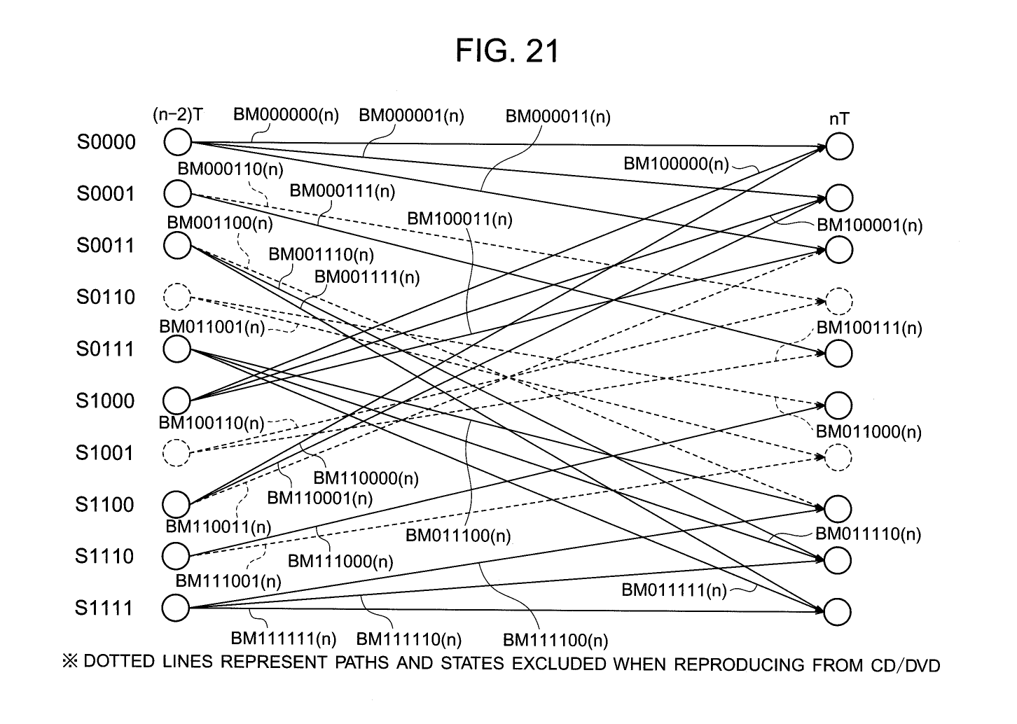

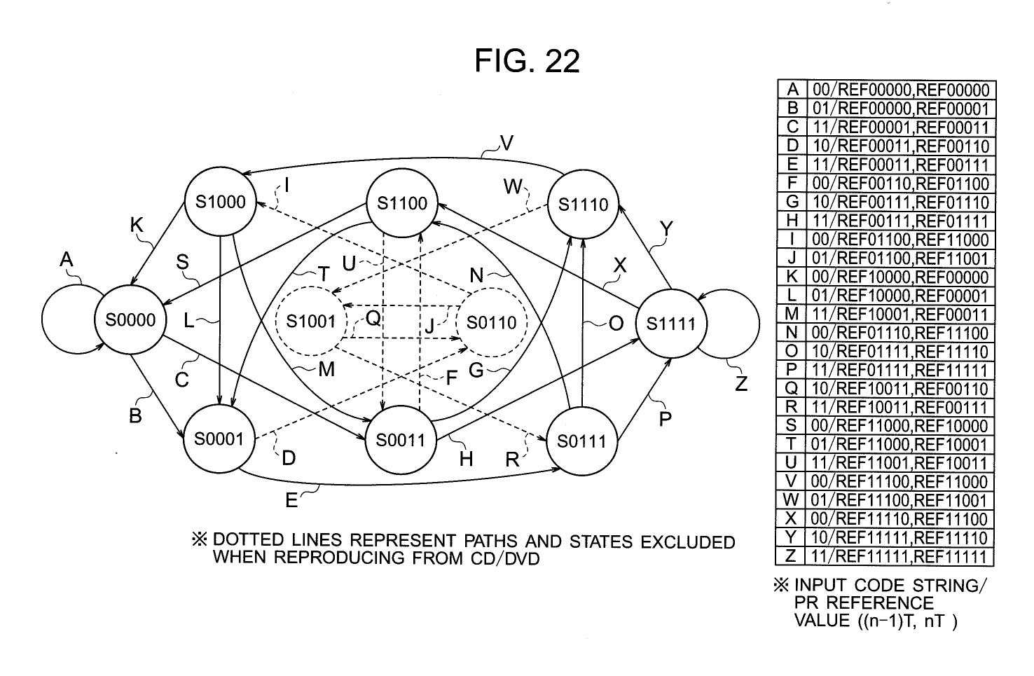

In this case, state transitions extending over three time points ranging from time (n−2)T to time nT (where n is a natural number) based upon timing of the channel clock shown in the trellis diagram in FIG. 4 become state transitions obtained by coupling state transitions from time (n−2)T to time (n−1)T with state transition states from time (n−1)T to time nT in the time direction, and it is represented by a trellis diagram shown in FIG. 21. Here, T represents a time length corresponding to one period based upon the timing of the channel clock. FIG. 22 is obtained by representing the trellis diagram shown in FIG. 21 as a state transition diagram. Parts indicated by dotted lines in FIGS. 21 and 22 represent paths and states on which a transition is not made when conducting reproduction processing on media having the shortest mark length 3T on the recording face of the disk, such as a CD or a DVD. In FIG. 21, branch metrics BM000000(n) to BM111111(n) are calculated according to the following equations.

BM000000(n)=BM00000(n−1)+BM00000(n) (Equation 4-1)

BM000001(n)=BM00000(n−1)+BM00001(n) (Equation 4-2)

BM000011(n)=BM00001(n−1)+BM00011(n) (Equation 4-3)

BM000110(n)=BM00011(n−1)+BM00110(n) (Equation 4-4)

BM000111(n)=BM00011(n−1)+BM00111(n) (Equation 4-5)

BM001100(n)=BM00110(n−1)+BM01100(n) (Equation 4-6)

BM001110(n)=BM00111(n−1)+BM01110(n) (Equation 4-7)

BM001111(n)=BM00111(n−1)+BM01111(n) (Equation 4-8)

BM011000(n)=BM01100(n−1)+BM11000(n) (Equation 4-9)

BM011001(n)=BM01100(n−1)+BM11001(n) (Equation 4-10)

BM011100(n)=BM01110(n−1)+BM11100(n) (Equation 4-11)

BM011110(n)=BM01111(n−1)+BM11110(n) (Equation 4-12)

BM011111(n)=BM01111(n−1)+BM11111(n) (Equation 4-13)

BM100000(n)=BM10000(n−1)+BM00000(n) (Equation 4-14)

BM100001(n)=BM10000(n−1)+BM00001(n) (Equation 4-15)

BM100011(n)=BM10001(n−1)+BM00011(n) (Equation 4-16)

BM100110(n)=BM10011(n−1)+BM00110(n) (Equation 4-17)

BM100111(n)=BM10011(n−1)+BM00111(n) (Equation 4-18)

BM110000(n)=BM11000(n−1)+BM10000(n) (Equation 4-19)

BM110001(n)=BM11000(n−1)+BM10001(n) (Equation 4-20)

BM110011(n)=BM11001(n−1)+BM10011(n) (Equation 4-21)

BM111000(n)=BM11100(n−1)+BM11000(n) (Equation 4-22)

BM111001(n)=BM11100(n−1)+BM11001(n) (Equation 4-23)

BM111100(n)=BM11110(n−1)+BM11100(n) (Equation 4-24)

BM111110(n)=BM11111(n−1)+BM11110(n) (Equation 4-25)

BM111111(n)=BM11111(n−1)+BM11111(n) (Equation 4-26)

In the equations, (n) represents a value at time nT. In the same way, (n−1) represents a value at time (n−1)T. BM00000(n−1) to BM11111(n−1) and BM00000(n) to BM11111(n) are values calculated from (Equation 1-1) to (Equation 1-16). In addition, path metrics PM0000(n) to PM1111(n) are calculated by the following equations. By the way, min {*, *, . . . , *} represents a function which selects a minimum value from among values indicated in { }.

PM0000(n)=min{PM0000(n−2)+BM000000(n),PM1000(n−2)+BM100000(n),PM1100(n−2)+BM110000(n)} (Equation 4-27)

PM0001(n)=min{PM0000(n−2)+BM000001(n),PM1000(n−2)+BM100001(n),PM1100(n−2)+BM110001(n)} (Equation 4-28)

PM0011(n)=min{PM0000(n−2)+BM000011(n),PM1000(n−2)+BM100011(n),PM1100(n−2)+BM110011(n)} (Equation 4-29)

PM0110(n)=min{PM0001(n−2)+BM000110(n),PM1001(n−2)+BM100110(n)} (Equation 4-30)

PM0111(n)=min{PM0001(n−2)+BM000111(n),PM1001(n−2)+BM100111(n)} (Equation 4-31)

PM1000(n)=min{PM0110(n−2)+BM011000(n),PM1110(n−2)+BM111000(n)} (Equation 4-32)

PM1001(n)=min{PM0110(n−2)+BM011001(n),PM1110(n−2)+BM111001(n)} (Equation 4-33)

PM1100(n)=min{PM0011(n−2)+BM001100(n),PM0111(n−2)+BM011100(n),PM1111(n−2)+BM111100(n)} (Equation 4-34)

PM1110(n)=min{PM0011(n−2)+BM001110(n),PM0111(n−2)+BM011110(n),PM1111(n−2)+BM111110(n)} (Equation 4-35)

PM1111(n)=min{PM0011(n−2)+BM001111(n),PM0111(n−2)+BM011111(n),PM1111(n−2)+BM111111(n)}(Equation 4-36)

In the equations, (n) represents a value at time nT. In the same way, (n−2) represents a value at time (n−2)T. Contents indicated by (Equation 4-27) to (Equation 4-36) are that the path metric is updated to cause a new path metric to become a result obtained by adding up an old path metric of two time periods before and a branch metric indicated by (Equation 4-1) to (Equation 4-26). Furthermore, in a state in which a plurality of paths meet, addition results are compared and a path having a smaller value is selected as a path having a higher likelihood. Paths having higher likelihoods are gradually selected by repeating the maximum likelihood decision using these path metrics every time reproduced signals corresponding to two time points are input. A decoding result is obtained by tracing paths which have survived finally.

If the first term in each of (Equation 4-1) to (Equation 4-26) is made equal to zero, then branch metrics BM000000(n) to BM111111(n) at the time of the half clock sampling are obtained. In this case, equations which yield equal calculation results appear like BM000000(n) and BM100000(n). If a numeral in the highest order among those suffixes is omitted and duplicated suffixes are rearranged, then the trellis diagram and the state transition diagram respectively shown in FIG. 21 and FIG. 22 become equal to FIG. 5 and FIG. 6, respectively. In other words, it is represented that the information reproduction apparatus according to the present embodiment can cope with the half clock sampling operation.

An outline of reproduction operation in the information reproduction apparatus according to the present embodiment will now be described.

As shown in FIG. 20, the PLL 2001 generates a channel clock synchronized to a digitized reproduced signal and a half clock which oscillates with a frequency which is half of that of the channel clock, and inputs the half clock to the Viterbi decoder 2002 and the decoder 113. Furthermore, the PLL 2001 selects the channel clock or the half clock on the basis of control from the controller 2008, and inputs the selected channel clock or half clock to the ADC 105, the equalizer 107, and the switch 2003. A clock shown in FIG. 20 represents the channel clock at the time of channel clock sampling, and represents the half clock at the time of half clock sampling. At the time of the channel clock sampling, the switch 2003 conducts changeover on an input from the equalizer 107 on the basis of control from the controller 2008 to input a reproduced signal sampled with the channel clock alternately to the BMC 2009 and the BMC 2010 every time point. Furthermore, at the time of the half clock sampling, the switch 2003 conducts changeover on the input from the equalizer 107 on the basis of control from the controller 2008 to continue to input the reproduced signal sampled with the half clock only to the BMC 2009. The BM adder 2004 calculates and outputs the branch metrics BM000000(n) to BM111111(n) indicated in (Equation 4-1) to (Equation 4-26) at the time of the channel clock sampling on the basis of control from the controller 2008. On the other hand, at the time of the half clock sampling, the BM adder 2004 generates and outputs the branch metrics BM000000(n) to BM111111(n) to cause them to become calculation results obtained when the first terms in (Equation 4-1) to (Equation 4-26) are replaced with zero, by using a method which is not illustrated. The ACS 2005 calculates path selection signals SEL0000(n) to SEL1111(n) at the current time and the path metrics PM0000(n) to PM1111(n) at the current time on the basis of the branch metrics BM000000(n) to BM111111(n) which are input and path metrics PM0000(n−2) to PM1111(n−2) of two time periods before which are input from the PM memory 2006. The calculated path selection signals SEL0000(n) to SEL1111(n) are input to the path memory 2007, and the path metrics PM0000(n) to PM1111(n) at the current time are overwritten in the PM memory 2006. The path memory 2007 updates path transition state information retained therein on the basis of the path selection signals SEL0000(n) to SEL1111(n) which are input, generates decoding data on the basis of the path transition state information, and inputs the generated decoding data to the decoder 113.

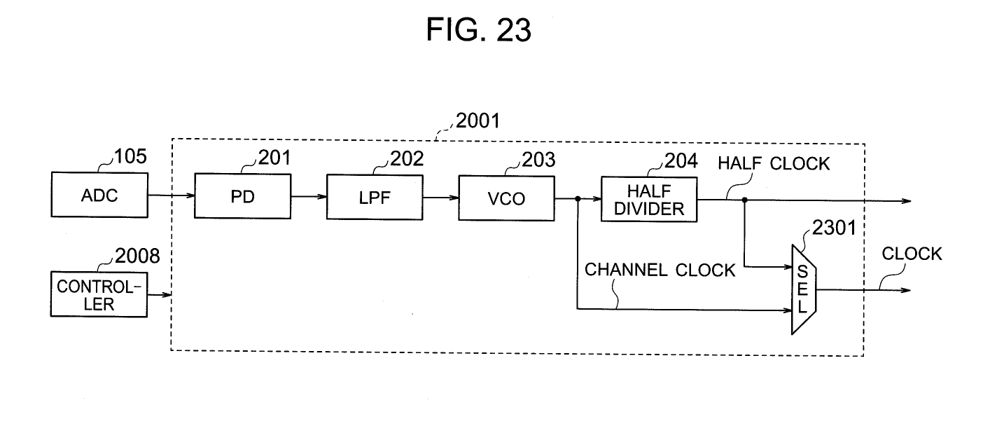

FIG. 23 shows an example of a configuration of the PLL 2001 shown in FIG. 20. FIG. 23 differs from FIG. 2 showing an example of the configuration of the PLL 106 in the embodiment 1 in that a controller 2008 and a selector 2301 are provided. The same reference numeral as that in FIG. 2 denotes a component which is like that in the embodiment 1, and its description will be omitted. The VCO 23 always generates a channel clock synchronized to the reproduced signal, and inputs the channel clock to the selector 2301. A half clock generated in the half divider 204 is input to a circuit in the subsequent stage as an output of the PLL 2001, and it is input to the selector 2301 as well. The selector 2301 selects one out of the half clock and the channel clock on the basis of control from the controller 2008, and outputs the selected clock.

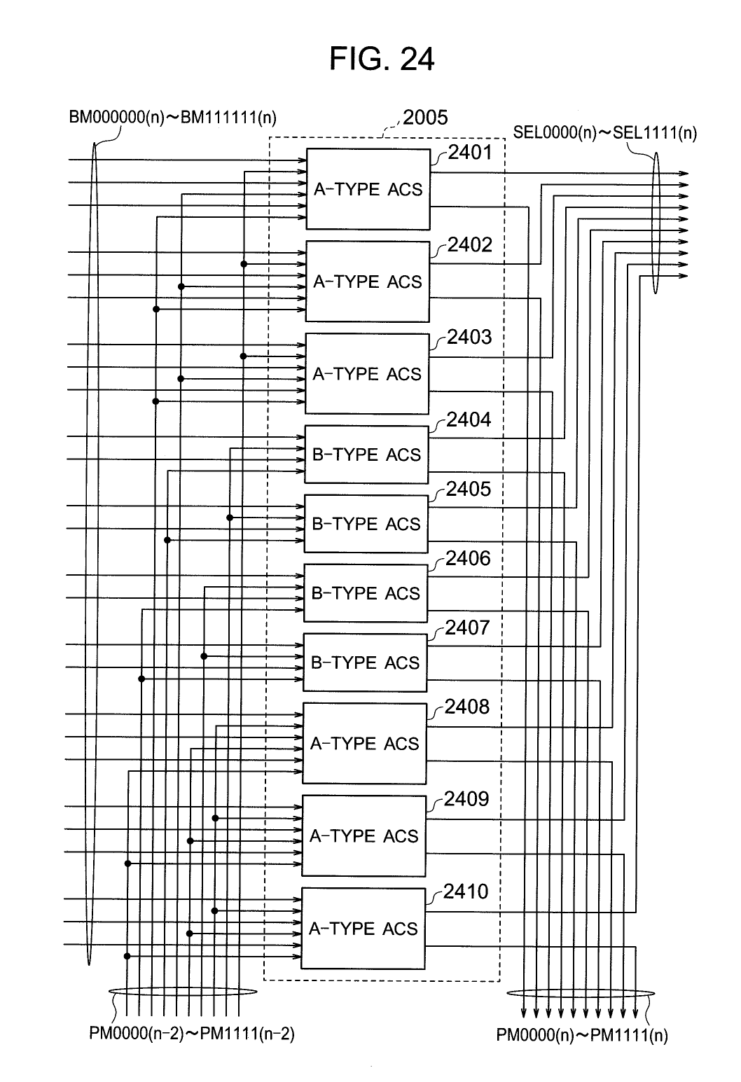

FIG. 24 shows details of the ACS 2005 shown in FIG. 20.

The ACS 2005 calculates path selection signals SEL0000(n) to SEL1111(n) at the current time and the path metrics PM0000(n) to PM1111(n) at the current time expressed by (Equation 4-27) to (Equation 4-36) on the basis of the branch metrics BM000000(n) to BM111111(n) calculated by the BM adder 2004 and the path metrics PM0000(n−2) to PM1111(n−2) of two time periods before which are recorded in the PM memory 2006, by using A-type ACSs 2401, 2402, 2403, 2408, 2409 and 2410 and B-type ACSs 2404, 2405, 2406 and 2407. The path metrics PM0000(n) to PM1111(n) at the current time are overwritten in the PM memory 2006, and the path selection signals SEL0000(n) to SEL1111(n) are output to the path memory 2007 in the subsequent stage.

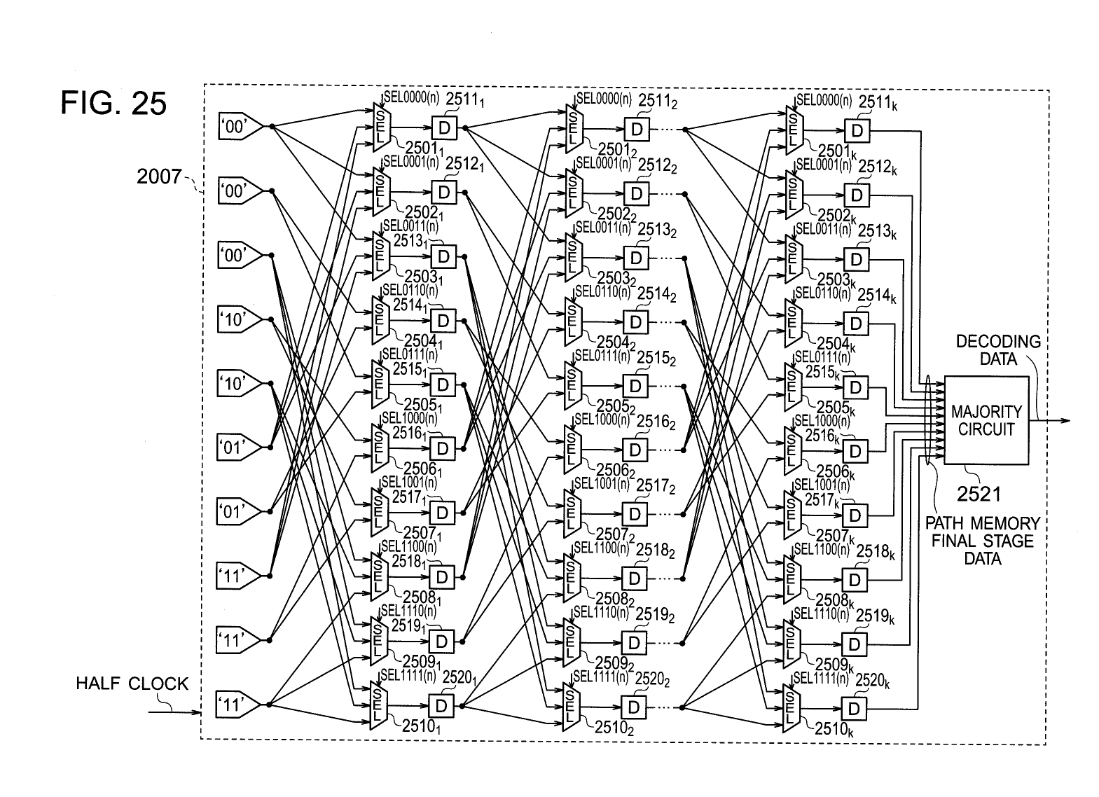

FIG. 25 shows details of the path memory 2007 shown in FIG. 20. Selectors 2501₁ to 2510₁, 2501₂ to 2510₂, and 2501ₖ to 2510ₖ select one out of a plurality of inputs on the basis of the path selection signals SEL0000(n) to SEL1111(n) which are input from the ACS 2005, and stores it in delay circuits 2511₁ to 2520₁, 2511₂ to 2520₂, and 2511ₖ to 2520ₖ, respectively. In FIG. 25, k indicates the number of transition stages of transition state information recorded in the path memory. A majority circuit 2521 conducts decision processing based on majority by using path memory final stage data which are input from the delay circuits 2511ₖ to 2520ₖ, and outputs decoding data. At the time of the half clock sampling operation, there are four pairs which assume the same value as a result of shrinking of transition states, among path memory final stage data. In this case, for example, a method of using only one data in each pair is used for a majority decision to prevent duplicate data from affecting a result of the majority decision should be used.

If the Viterbi decoding coping with both the half clock sampling and the channel clock sampling described heretofore is used, it becomes possible to change over to suitable Viterbi decoding according to the quality of the reproduced signal. For example, it becomes possible to reduce power consumption by applying Viterbi coding corresponding to the half clock sampling if distortion and noise contained in the reproduced signal from the optical disk are slight (for example, when reproducing from a high quality disk) and improve the decoding precision by changing over to the Viterbi decoding corresponding to the channel clock sampling if distortion and noise contained in the reproduced signal is much (for example, when reproducing from a coarse disk). As for a decision method as to changeover between the half clock sampling operation and the channel clock sampling operation, a method of making a decision as to changeover in response to a retry operation or a double speed operation, or a method of making a decision as to changeover on the basis of a discriminated kind of the disk should be used. Or the user may previously select the operation of the channel clock sampling or the half clock sampling and set it.

Furthermore, since the channel clock sampling operation and the half clock sampling operation can be implemented by using the same Viterbi decoder, implementation in a small circuit scale is possible. In the present embodiment, the method of excluding duplicate operation results from objects of the majority decision processing is used at the time of the half clock sampling in order to prevent the influence of duplicate operation results caused by shrinking of transition states. Alternatively, however, a method of stopping an operation device for transition states causing shrinking may be used.

Furthermore, the partial response in the above-described Viterbi decoding may be either of an adaptively changed value and a fixed value. Furthermore, the restraint length of the PRML is not restricted to the described length, either. In the foregoing description, it is supposed as an embodiment that the operation clock is the half clock oscillating with a frequency which is half of that of the channel clock. Alternatively, however, a frequency obtained by applying frequency division with an arbitrary value to the channel clock may be used.

### Fifth Embodiment

The present embodiment is an embodiment capable of improving the drop of the signal precision in Viterbi decoding corresponding to the half clock sampling by using pseudo channel clock sampling in which a signal corresponding to a reproduced signal thinned by the half clock sampling is generated by the use of interpolation processing and channel clock sampling is conducted in a pseudo manner.

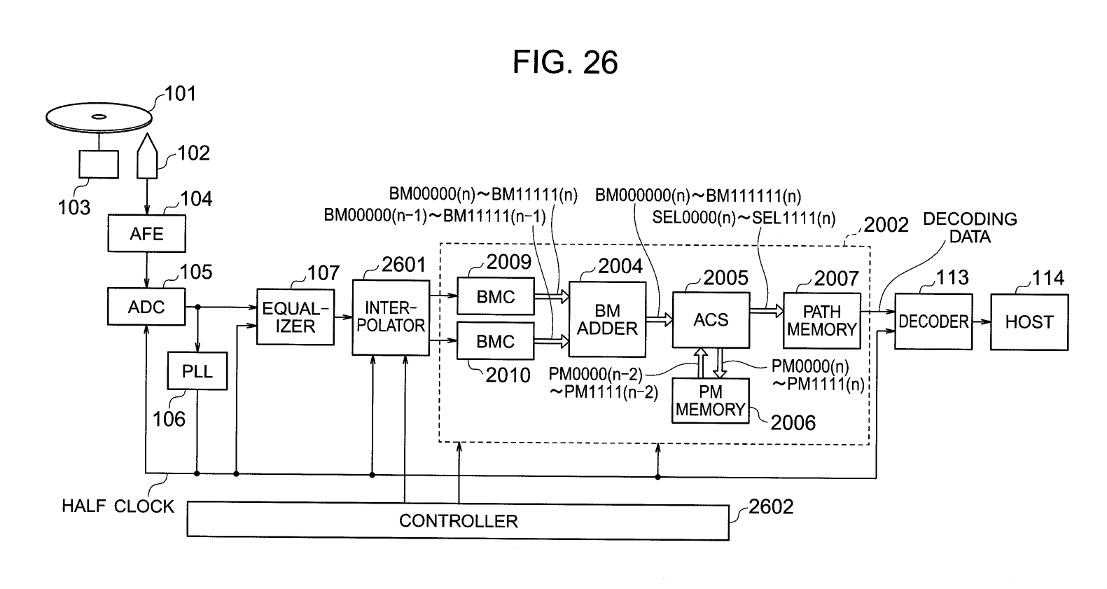

FIG. 26 is a configuration diagram of an information reproduction apparatus according to a fifth embodiment of the present invention. FIG. 26 differs from FIG. 20 showing the information reproduction apparatus according to the fourth embodiment in that the PLL 106, an interpolator 2601, and a controller 2602 are provided. The same reference numeral as that in FIG. 20 denotes a component which is like that in the embodiment 4, and its description will be omitted. Furthermore, as to a component already described in the foregoing description as well, description thereof will be omitted.

In FIG. 26, the interpolator 2601 conducts interpolation processing by using a reproduced signal subjected to waveform equalization in the equalizer 107, and generates a signal corresponding to a reproduced signal thinned by half clock sampling. And the interpolator 2601 outputs the signal generated by the interpolation to the BMC 2010, and outputs the reproduced signal subjected to the waveform equalization which is input from the equalizer 107 to the BMC 2009.

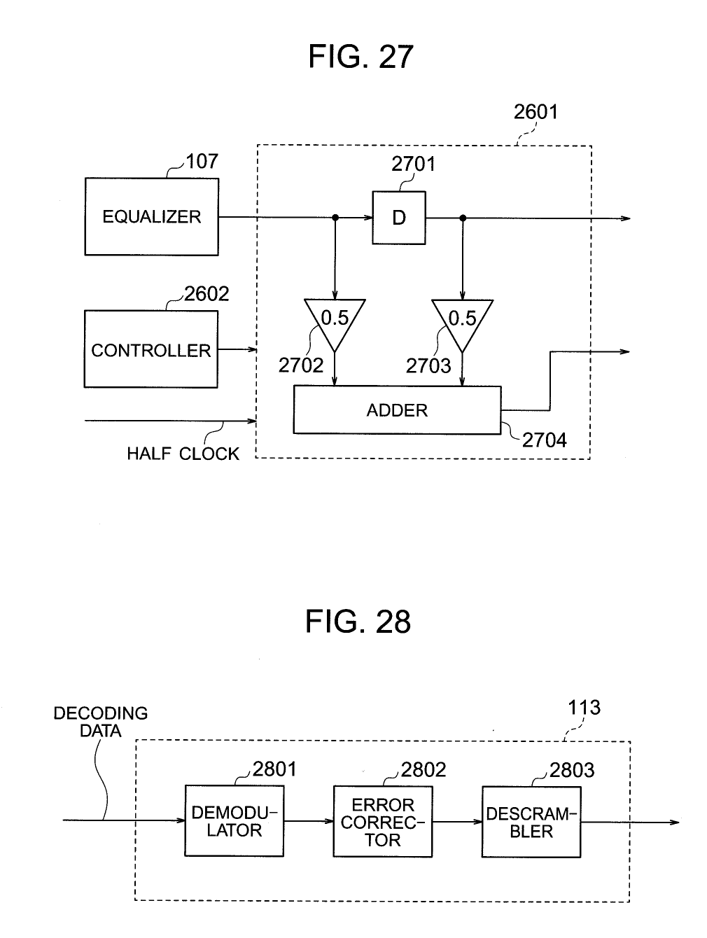

FIG. 27 shows an example of a configuration of the interpolator 2601 shown in FIG. 26.

The reproduced signal subjected to the waveform equalization and supplied from the equalizer 107 is input to a delay circuit 2701 and a 0.5-times multiplier 2702. A signal stored in the delay circuit 2701 is output to a 0.5-times multiplier 2703 and the BMC 2009 in the subsequent stage. An adder 2704 adds up signals obtained by 0.5 times multiplication in the 0.5-times multipliers 2702 and 2703, and outputs a result of the addition to the BMC 2010 in the subsequent stage.

If the Viterbi decoding coping with both the half clock sampling and the pseudo channel clock sampling described heretofore is used, it becomes possible to change over to suitable Viterbi decoding according to the quality of the reproduced signal. For example, it becomes possible to reduce power consumption by applying Viterbi coding corresponding to the half clock sampling if distortion and noise contained in the reproduced signal from the optical disk are slight (for example, when reproducing from a high quality disk) and improve the decoding precision by changing over to the Viterbi decoding corresponding to the pseudo channel clock sampling using interpolation processing if distortion and noise contained in the reproduced signal is much (for example, when reproducing from a coarse disk). As for a decision method as to changeover between the half clock sampling operation and the pseudo channel clock sampling operation, a method of making a decision as to changeover in response to a retry operation or a double speed operation, or a method of making a decision as to changeover on the basis of a discriminated kind of the disk should be used. Or the user may previously select the operation of the channel clock sampling or the half clock sampling and set it.

In the present embodiment, linear interpolation between two points is used as the scheme for reproduced signal interpolation. However, the scheme for reproduced signal interpolation is not restricted to the linear interpolation between two points.

By the way, the circuit configuration using the reproduced signal interpolation scheme described heretofore is not restricted to the present embodiment, but it can be applied to the forgoing embodiment as well.

Furthermore, the partial response in the above-described Viterbi decoding may be either of an adaptively changed value and a fixed value. Furthermore, the restraint length of the PRML is not restricted to the described length, either. In the foregoing description, it is supposed as an embodiment that the operation clock is the half clock oscillating with a frequency which is half of that of the channel clock. Alternatively, however, a frequency obtained by applying frequency division with an arbitrary value to the channel clock may be used.

It should be further understood by those skilled in the art that although the foregoing description has been made on embodiments of the invention, the invention is not limited thereto and various changes and modifications may be made without departing from the spirit of the invention and the scope of the appended claims.

1. An information reproduction apparatus for reproducing information, comprising:
a clock generation means for generating a channel clock synchronized to input data;
an analog/digital conversion means for conducting analog/digital conversion on the input data with an 1/N clock oscillating at a frequency equivalent to one Nth (where N is a positive real number) of that of the channel clock; and
a Viterbi decoding means for conducting Viterbi decoding,
the Viterbi decoding means comprising:
a branch metric operation means for calculating a branch metric based on a difference between an output of the analog/digital conversion means and a reference value;
an ACS operation means responsive to input of data corresponding to one time point based upon the 1/N clock, for adding up the branch metric corresponding to one time point of the 1/N clock and an old path metric, comparing results of the addition in magnitude, selecting a smaller addition result, and outputting a new path metric and a path selection signal, in accordance with state transitions in which a state makes a transition with N bits taken as a unit;
a maximum likelihood path decision means for determining a maximum likelihood path based on the path selection signal; and
a decoding means for conducting decoding based on the maximum likelihood path and outputting a decoding result.

2. The information reproduction apparatus according to claim 1, wherein the 1/N clock is a half clock.

3. The information reproduction apparatus according to claim 1, wherein an input of the branch metric operation means is obtained by equalizing the output of the analog/digital conversion means to desired characteristics.

4. An information reproduction apparatus for reproducing information, comprising:
a clock generation means for generating at least one of a channel clock synchronized to input data and an 1/N clock oscillating with a frequency which is equal to 1/N of that of the channel clock (where N is a positive real number);
an analog/digital conversion means for conducting analog/digital conversion on the input data with an output of the clock generation means; and
a Viterbi decoding means for conducting Viterbi decoding,
the Viterbi decoding means comprising:
a branch metric operation means for calculating a branch metric based on a difference between an output of the analog/digital conversion means and a reference value;
a first ACS operation means responsive to input of data corresponding to one time point based upon the 1/N clock, for adding up the branch metric corresponding to one time point of the 1/N clock and an old first path metric, comparing results of the addition in magnitude, selecting a smaller addition result, and outputting a new first path metric and a first path selection signal, in accordance with state transitions in which a state makes a transition with N bits taken as a unit;
a second ACS operation means responsive to input of data corresponding to one time point based upon the channel clock, for adding up the branch metric corresponding to one time point of the channel clock and an old second path metric, comparing results of the addition in magnitude, selecting a smaller addition result, and outputting a new second path metric and a second path selection signal, in accordance with state transitions in which a state makes a transition with one bit taken as a unit;
a first maximum likelihood path decision means for determining a first maximum likelihood path based on the first path selection signal;
a second maximum likelihood path decision means for determining a second maximum likelihood path based on the second path selection signal;
a first decoding means for conducting decoding based on the first maximum likelihood path and outputting a first decoding result;
a second decoding means for conducting decoding based on the second maximum likelihood path and outputting a second decoding result;
a data changeover means for changing over between the first decoding result and the second decoding result and outputting a resultant decoding result; and
a control means for controlling the clock generation means and the data changeover means.

5. The information reproduction apparatus according to claim 4, wherein pseudo data corresponding to data to be obtained by conducting analog/digital conversion with the channel clock is generated by conducting data interpolation using the output of the analog/digital conversion means corresponding to a plurality of time points based upon the 1/N clock, and the pseudo data is input to the branch metric operation means

6. The information reproduction apparatus according to claim 4, wherein if an uncorrectable error is detected in error correction processing while an operation based upon the 1/N clock is being executed, then the control means controls the clock generation means and the data changeover means to conduct changeover to an operation based upon the channel clock and execute retry processing.

7. The information reproduction apparatus according to claim 4, wherein in response to setting of a double speed operation, the control means controls the clock generation means and the data changeover means to conduct changeover between an operation based upon the channel clock and an operation based upon the 1/N clock.

8. The information reproduction apparatus according to claim 4, wherein when the input data is read out from a recording medium, the control means controls the clock generation means and the data changeover means to conduct changeover between an operation based upon the channel clock and an operation based upon the 1/N clock, on the basis of a discriminated kind of the recording medium.

9. The information reproduction apparatus according to claim 4, wherein the control means controls the clock generation means and the data changeover means to conduct changeover between an operation based upon the channel clock and an operation based upon the 1/N clock, on the basis of contents of a sampling operation which is set by a user.

10. An information reproduction apparatus for reproducing information, comprising:
a clock generation means for generating a channel clock synchronized to input data and an 1/N clock oscillating with a frequency which is equal to 1/N of that of the channel clock (where N is a positive real number);
a clock changeover means for conducting changeover between the channel clock and the 1/N clock to output either one of the clocks;
a control means for controlling the clock changeover means;
an analog/digital conversion means for conducting analog/digital conversion on the input data with an output of the clock generation means; and
a Viterbi decoding means for conducting Viterbi decoding,
the Viterbi decoding means comprising:
a first branch metric operation means for calculating a first branch metric based on a difference between an output of the analog/digital conversion means and a reference value;
a second branch metric operation means for calculating a second branch metric based on a difference between the output of the analog/digital conversion means and a reference value;
a branch metric addition means for adding up the first branch metric and the second branch metric;
an ACS operation means responsive to input of continuous data corresponding to N time points based upon the channel clock, for adding up an output of the branch metric addition means and an old first path metric, comparing results of the addition in magnitude, selecting a smaller addition result, and outputting a new first path metric and a path selection signal, in accordance with state transitions in which a state makes a transition with N bits taken as a unit;
a maximum likelihood path decision means for determining a maximum likelihood path based on the path selection signal; and
a decoding means for conducting decoding based on the maximum likelihood path and outputting a decoding result.

11. The information reproduction apparatus according to claim 10, wherein pseudo data corresponding to data to be obtained by conducting analog/digital conversion with the channel clock is generated by conducting data interpolation using the output of the analog/digital conversion means corresponding to a plurality of time points based upon the 1/N clock, and the pseudo data is input to the first branch metric operation means and the second branch metric operation means.

12. The information reproduction apparatus according to claim 10, wherein if an uncorrectable error is detected in error correction processing while an operation based upon the 1/N clock is being executed, then the control means controls the clock changeover means to conduct changeover to an operation based upon the channel clock and execute retry processing.

13. The information reproduction apparatus according to claim 10, wherein in response to setting of a double speed operation, the control means controls the clock changeover means to conduct changeover between an operation based upon the channel clock and an operation based upon the 1/N clock.

14. The information reproduction apparatus according to claim 10, wherein when the input data is read out from a recording medium, the control means controls the clock changeover means to conduct changeover between an operation based upon the channel clock and an operation based upon the 1/N clock, on the basis of a discriminated kind of the recording medium.

15. The information reproduction apparatus according to claim 10, wherein the control means controls the clock changeover means to conduct changeover between an operation based upon the channel clock and an operation based upon the 1/N clock, on the basis of contents of a sampling operation which is set by a user.

16. An information reproduction method for reproducing information, comprising:
generating a channel clock synchronized to input data;
conducting analog/digital conversion on the input data with an 1/N clock oscillating at a frequency equivalent to one Nth (where N is a positive real number) of that of the channel clock; and
conducting Viterbi decoding,
the Viterbi decoding comprising:
calculating a branch metric based on a difference between a result of the analog/digital conversion and a reference value;
responding to input of data corresponding to one time point based upon the 1/N clock, by adding up the branch metric corresponding to one time point of the 1/N clock and an old path metric, comparing results of the addition in magnitude, selecting a smaller addition result, and outputting a new path metric and a path selection signal, in accordance with state transitions in which a state makes a transition with N bits taken as a unit;
determining a maximum likelihood path based on the path selection signal; and
conducting decoding based on the maximum likelihood path and calculating a decoding result.

17. An information reproduction method for reproducing information, comprising:
generating at least one of a channel clock synchronized to input data and an 1/N clock oscillating with a frequency which is equal to 1/N of that of the channel clock (where N is a positive real number) as a clock;
conducting analog/digital conversion on the input data with the clock; and
conducting Viterbi decoding,
the Viterbi decoding comprising:
calculating a branch metric based on a difference between a result of the analog/digital conversion and a reference value;
responding to input of data corresponding to one time point based upon the 1/N clock, by adding up the branch metric corresponding to one time point of the 1/N clock and an old first path metric, comparing results of the addition in magnitude, selecting a smaller addition result, and outputting a new first path metric and a first path selection signal, in accordance with state transitions in which a state makes a transition with N bits taken as a unit;
responding to input of data corresponding to one time point based upon the channel clock, by adding up the branch metric corresponding to one time point of the channel clock and an old second path metric, comparing results of the addition in magnitude, selecting a smaller addition result, and outputting a new second path metric and a second path selection signal, in accordance with state transitions in which a state makes a transition with one bit taken as a unit;
determining a first maximum likelihood path based on the first path selection signal;
determining a second maximum likelihood path based on the second path selection signal;
conducting decoding based on the first maximum likelihood path and calculating a first decoding result;
conducting decoding based on the second maximum likelihood path and calculating a second decoding result;
changing over between the first decoding result and the second decoding result and calculating a resultant decoding result;
and
controlling changeover between generation of the channel clock and generation of the 1/N clock and changeover between the first decoding result and the second decoding result.

18. An information reproduction method for reproducing information, comprising:
generating at least one of a channel clock synchronized to input data and an 1/N clock oscillating with a frequency which is equal to 1/N of that of the channel clock (where N is a positive real number) as a clock;
conducting analog/digital conversion on the input data with the clock; and
conducting Viterbi decoding,
the Viterbi decoding comprising:
calculating a first branch metric based on a difference between a result of the analog/digital conversion and a reference value;
calculating a second branch metric based on a difference between the result of the analog/digital conversion and a reference value;
adding up the first branch metric and the second branch metric;
responding to input of continuous data corresponding to N time points based upon the channel clock, by adding up a result of the addition of the first branch metric and the second branch metric and an old first path metric, comparing results of the addition in magnitude, selecting a smaller addition result, and calculating a new first path metric and a path selection signal, in accordance with state transitions in which a state makes a transition with N bits taken as a unit;
determining a maximum likelihood path based on the path selection signal; and
conducting decoding based on the maximum likelihood path and calculating a decoding result.
